(19) United States
(12) Patent Application Publication
(10) Pub. No.: US 2025/0132572 A1
(43) Pub. Date: Apr. 24, 2025

(54) COOPERATIVE AUTONOMOUS DISTRIBUTED GRID INTERCONNECTION SYSTEM, GRID INTERCONNECTION METHOD, AND PROGRAM

(71) Applicant: DG Capital Group Co. Ltd., Aichi (JP)

(72) Inventors: Rikiya ABE, Aichi (JP); Simon WALL, Faversham (GB)

(21) Appl. No.: 19/002,701

(22) Filed: Dec. 27, 2024

Related U.S. Application Data
(63) Continuation of application No. PCT/JP2023/003722, filed on Feb. 6, 2023.

(30) Foreign Application Priority Data
Jun. 28, 2022 (JP) 2022-103234

(51) Int. Cl. H02J 3/44; H02J 3/00; H02J 3/38; H02J 13/00

(52) U.S. Cl. CPC H02J 3/44; H02J 3/001; H02J 3/381; H02J 13/0004; H02J 2203/10

(57) ABSTRACT

In a cooperative autonomous distributed grid interconnection system, each of the cooperative autonomous distributed devices receives frequency information and phase information transmitted from the grid interconnection controller based on a standard time signal, or a combined signal of the frequency information and the phase information. When the synchronization checking circuit breaker is open, each or the cooperative autonomous distributed devices controls a voltage phase of the cell grid system so that the voltage phase of the cell grid system is synchronized with that of the main grid. When the synchronization checking circuit breaker is closed, each of the cooperative autonomous distributed devices controls a power flow between the main grid and the cell grid system.

### RELATED APPLICATIONS

The present application is a Continuation Application of International Application No. PCT/JP2023/003722 filed Feb. 6, 2023, which claims priority to Japanese Application No. 2022-103234, filed Jun. 28, 2022, the disclosures of which applications are hereby incorporated by reference herein in their entirety.

### TECHNICAL FIELD

The present invention relates to a cooperative autonomous distributed grid interconnection system, a grid interconnection method, and a program.

### BACKGROUND ART

In recent years, there has been a growing demand for local production and consumption of electricity, where electric power generated by power generation facilities using renewable energy and the like is consumed within the same region. For this purpose, a scheme called mini-grid or micro-grid, which involves sectioning and managing a power system including one or a plurality of power generation facilities, has been known. The alternating-current system within the mini-grid is synchronized by inverters disposed on the output sides of the power generation facilities.

Patent Literature 1 describes a method for independently managing a micro-grid. According to Patent Literature 1, the output voltage values and phases of inverters disposed at the respective outputs of a plurality of power generation facilities within the micro-grid are adjusted with reference to time signals obtained from the GPS. Moreover, real power and reactive power are feedback-controlled based on the actual serial impedance of the micro-grid. Interconnection with another micro-grid needs a central energy management system.

Cited Literature 2 describes power conversion apparatuses that are controlled in the same phase by inverters that are disposed at the respective outputs of a plurality of power generation facilities within a micro-grid correcting the time of their internal clocks with reference to time signals obtained from the GPS or the like. According to Cited Literature 2, the micro-grid has a fixed frequency, and an asynchronous interconnection power converter for performing AC-DC-AC power conversion is therefore provided to connect the power system within the micro-grid with the main grid.

Cited Literature 3 describes a method for independently controlling a micro-grid at a fixed frequency using a PMU (Phasor Measurement Unit). The PMU measures the voltage phase and current phase of the power system within the micro-grid. The measured phase information is used as a reference in the synchronous fixed frequency control of inverters connected to the outputs of the respective power generation facilities. Cited Literature 3 also describes compensation using compensating virtual impedance, with the impedance from the output of each power generation facility to the power system within the micro-grid being regarded as a common reference impedance.

Cited Literature 4 describes a method for performing current control on a power converter in a micro-grid. The method includes controlling an AC voltage waveform by manipulating the phases of real and reactive currents, with the converter connected to an AC power source being regarded as a virtual voltage source with virtual impedance. A droop control method is employed as a method for manipulating an instantaneous current, and is combined with current limiting and a maximum power point tracking (MPPT) method.

### CITATION LIST

### Patent Literature

Patent Literature 1: US2016/0329709A1
Patent Literature 2: JP-B-6863564
Patent Literature 3: LU500171B1
Patent Literature 4: U.S. Pat. No. 10,008,854B1

### SUMMARY OF INVENTION

### Technical Problem

To coordinate with the main grid using the method for independently managing the micro-grid according to the foregoing Patent Literature 1, a separate central energy management system that controls the entire system in a comprehensive manner is needed. As a result, the system for interconnecting the power system within the micro-grid with the main grid becomes large in scale so that the entire power system can be controlled in a comprehensive manner, and the communication system also becomes large in scale. There has thus been a problem that steep fluctuations are difficult to follow due to communication delays of the communication system.

As for the power conversion apparatuses according to the foregoing Patent Literature 2, the micro-grid has a fixed frequency, and the asynchronous interconnection power converter for performing AC-DC-AC power conversion is provided to interconnect the power system within the micro-grid with the main grid. The frequency and phase of the power system within the micro-grid therefore do not need to be synchronized with those of the main grid upon grid interconnection. However, the asynchronous grid interconnection apparatus described in the foregoing Patent Literature 2 interconnects the power system within the micro-grid with the main grid via the AC-DC-AC converter. The use of such an asynchronous grid inter connection apparatus limits the interconnectable power capacity, restricts the conductible current, and results in an increase in the apparatus size. The protective measures for consumers within the power system in an area including power facilities using renewable energy are set based on the magnitude of the short-circuit current to be supplied from the main grid. The interposition of the AC-DC-AC converter makes a sufficient short-circuit current difficult to supply, and there has been a problem that the protective circuit can fail to be triggered in the event of a short-circuit fault at a consumer's premises.

The synchronous fixed frequency control technique according to the foregoing Patent Literature 3 independently and synchronously operates the power system within the micro-grid at a fixed frequency. However, for example, the main grid frequency in Japan fluctuates within 50 Hz±0.2 Hz, and there has been a problem that the power system within the micro-grid is unable to be interconnected with the main grid if its frequency is fixed.

The method for controlling the inverter amplitude and phase according to the foregoing Patent Literature 4 can adopt an appropriate droop technique by which desired real- and reactive-phase currents are determined as functions of the voltage and frequency of the power system within the micro-grid, such a phase shift virtual voltage-virtual impedance droop or the like. This, however, is a patent related to a technique for controlling an inverter to be connected to a power system. Independent synchronous operation of a micro-grid using the proposed inverter control technique is not included, nor is there mention of a technique for synchronously connecting the micro-grid to the main grid.

In view of this, an object of the present invention is to provide a cooperative autonomous distributed grid interconnection system that synchronizes a large number of cooperative autonomous distributed devices in a power distribution system (hereinafter, referred to as a “cell grid”) that is disconnected at least at one location by a circuit breaker capable of disconnecting a main grid to enable independent operation of the cell grid, while always allowing synchronous connection with the main grid.

### Solution to Problem

The foregoing object of the present invention can be achieved by the following configurations. Specifically, a cooperative autonomous distributed grid interconnection system according to a first aspect of the present invention is a cooperative distributed grid interconnection system including: a synchronization checking circuit breaker (21) that is capable of connecting or disconnecting a main grid (15) and a cell grid system (28); a grid interconnection controller (MGC 30) that detects power information about the main grid (15) and power information about the cell grid system (28); and one or more cooperative autonomous distributed devices (DGR 40) that are connected within the cell grid system and perform power conversion to synchronously interconnect with each other, wherein: the grid interconnection controller (MGC 30) and each of the cooperative autonomous distributed devices (DGR 40) include a standard time signal acquisition device that acquires a standard time signal; each of the cooperative autonomous distributed devices (DGR 40) receives frequency information and phase information transmitted from the grid interconnection controller (MGC 30) based on the standard time signal, or a combined signal of the frequency information and the phase information; when the synchronization checking circuit breaker (21) is open, each of the cooperative autonomous distributed devices (DGR 40) controls a voltage phase of the cell grid system so that the voltage phase of the cell grid system is synchronized with that of the main grid; and when the synchronization checking circuit breaker (21) is closed, each of the cooperative autonomous distributed devices (DGR 40) controls a power flow between the main grid and the cell grid system.

A cooperative autonomous distributed grid interconnection system according to a second aspect of the present invention is the cooperative autonomous distributed grid interconnection system according to the first aspect, wherein: the grid interconnection controller (MGC 30) generates an inter-grid phase difference signal (ϕglobal) and transmits the inter-grid phase difference signal to each of the cooperative autonomous distributed devices (DGR 40); when the synchronization checking circuit breaker (21) is closed, each of the cooperative autonomous distributed devices (DGR 40) controls the power flow and a reverse power flow using the inter-grid phase difference signal (ϕglobal); and even if the synchronization checking circuit breaker (21) is open and information from the grid interconnection controller (MGC 30) is unable to be received, each of the cooperative autonomous distributed devices (DGR 40) can perform synchronization control on the cell grid system based on the standard time signal.

A cooperative autonomous distributed grid interconnection system according to a third aspect of the present invention is the cooperative autonomous distributed grid interconnection system according to the first aspect, wherein: the standard time signal acquisition device includes a first standard time acquisition unit (32) that acquires a first standard time signal, and a second standard time acquisition unit (42) that acquires a second standard time signal; the grid interconnection controller (MGC 30) includes the first standard time acquisition unit (32), generates a phase synchronization signal (Ncyc_ref_Sync) as the combined signal of the frequency information and the phase information by applying the first standard time signal (t) to a main grid frequency (f) and a main grid rotational phase angle (θref), and outputs the phase synchronization signal (Ncyc_ref_Sync) to the cooperative autonomous distributed device (DGR 40); and the cooperative autonomous distributed device (DGR 40) includes the second standard time acquisition unit (42), and demodulates a cell grid system rotational phase angle signal (θref′) synchronous with the main grid rotational phase angle (θref) by applying the second standard time signal (t′) to the phase synchronization signal (Ncyc_ref_Sync) output from the grid interconnection controller (MGC 30) and the main grid frequency (f).

A cooperative autonomous distributed grid interconnection system according to a fourth aspect of the present invention is the cooperative autonomous distributed grid interconnection system according to the first aspect, wherein: the grid interconnection controller (MGC 30A) measures a main grid frequency measurement value (f) with the power information about the main grid and/or the power information about the cell grid system as an input, generates the inter-grid phase difference signal (ϕglobal), and outputs the inter-grid phase difference signal (ϕglobal) to the cooperative autonomous distributed device (DGR 40A); and the cooperative autonomous distributed device (DGR 40A) generates a cell grid system phase angle signal (θpll) and a cell grid system angular velocity signal (ωpll) from the cell grid system voltage (Vgrid_mini), and calculates a cell grid system rotational phase angle signal (θref) from the cell grid system phase angle signal (θpll), the cell grid system angular velocity signal (ωpll), the main grid frequency measurement value (f), and the inter-grid phase difference signal (ϕglobal).

A cooperative autonomous distributed grid interconnection system according to a fifth aspect of the present invention is the cooperative autonomous distributed grid interconnection system according to the fourth aspect, wherein: the grid interconnection controller (MGC 30B) measures the main grid frequency measurement value (f) using a first phase synchronization circuit (96a); the cooperative autonomous distributed device (DGR 40B) generates the cell grid system phase angle signal (θpll) and the cell grid system angular velocity signal (ωpll) using a second phase synchronization circuit (83); and the standard time signal acquisition device includes a first standard time acquisition unit (32) that inputs a first standard time (t) to the first phase synchronization circuit (96a), and a second standard time acquisition unit (42) that inputs a second standard time (t′) to the second phase synchronization circuit (83).

A cooperative autonomous distributed grid interconnection system according to a sixth aspect of the present invention is the cooperative autonomous distributed grid interconnection system according to the first aspect, wherein if the cell grid system (28) is capable of connecting to a plurality of main grids (15a and 15b) via the synchronization checking circuit breakers (21a and 21b) and an abnormality occurs in a first main grid (15a) among the main grids, the cell grid system (28) can interconnect with a second main grid (15b) other than the first main grid (15a) and transmit power to an area (15a1) where the abnormality is not occurring in the first main grid (15a).

A cooperative autonomous distributed grid interconnection system according to a seventh aspect of the present invention is the cooperative autonomous distributed grid interconnection system according to the first aspect, wherein: if the synchronization checking circuit breaker (21) is closed and the main grid (15) experiences an outage, the synchronization checking circuit breaker (21) is switched from closed to open, and each of the cooperative autonomous distributed devices (DGR 40) independently operates the cell grid system (28); and if the synchronization checking circuit breaker (21) is open and a fault occurs in the cell grid system, the synchronization checking circuit breaker (21) is closed and the power flow is controlled to supply a fault current to a fault point, so that a protective relay at the fault point is triggered to cut off the fault point.

A cooperative autonomous distributed grid interconnection system according to an eighth aspect of the present invention is the cooperative autonomous distributed grid interconnection system according to the first aspect, wherein the cooperative autonomous distributed device includes a common unit (120) including a motherboard (123), and one or more individual units (130), and the motherboard (123) performs control calculation including pulse wave generation.

A cooperative autonomous distributed grid interconnection system according to a ninth aspect of the present invention is the cooperative autonomous distributed grid interconnection system according to the eighth aspect, wherein calculation for the pulse wave generation by the motherboard (123) uses hysteresis control.

A grid interconnection method of a cooperative autonomous distributed grid interconnection system according to a tenth aspect of the present invention is a grid interconnection method of a cooperative distributed grid interconnection system including: a synchronization checking circuit breaker (21) that is capable of connecting or disconnecting a main grid (15) and a cell grid system (28); a grid interconnection controller (MGC 30) that detects power information about the main grid (15) and power information about the cell grid system (28); and one or more cooperative autonomous distributed devices (DGRs 40) that are connected within the cell grid system and perform power conversion to synchronously interconnect with each other, the grid interconnection method including: a step in which the grid interconnection controller (MGC 30) and each of the cooperative autonomous distributed devices (DGR 40) acquire a standard time signal; a step in which each of the cooperative autonomous distributed devices receives frequency information and phase information transmitted from the grid interconnection controller (MGC 30) based on the standard time signal, or a combined signal of the frequency information and the phase information; a step in which, when the synchronization checking circuit breaker (21) is open, each of the cooperative autonomous distributed devices (DGR 40) controls a voltage phase of the cell grid system (28) so that the voltage phase of the cell grid system is synchronized with that of the main grid; and a step in which, when the synchronization checking circuit breaker (21) is closed, each of the cooperative autonomous distributed devices (DGR 40) controls a power flow between the main grid (15) and the cell grid system (28).

A program according to an eleventh aspect of the present invention causes a computer to perform the steps of the grid interconnection method of the cooperative autonomous distributed grid interconnection system according to the tenth aspect.

### Advantageous Effects of Invention

According to the cooperative autonomous distributed grid interconnection system of the first aspect of the present invention, the cooperative autonomous distributed devices are distributed within the cell grid and function as voltage sources that interconnect with each other, whereby the voltage of the cell grid can be established. The cell grid system (28) can be constantly synchronized with the main grid (15) in frequency and phase, and the cooperative autonomous distributed devices are capable of synchronization even in numbers and can thus be reduced in size. Since the capacity of each cooperative autonomous distributed device is set based on the connected power generation facilities, a protective operation using a short-circuit current is appropriately performed in the event of abnormalities. In addition, since the power capacity within the cell grid can be freely adjusted based on the number of cooperative autonomous distributed devices installed, sufficient power capacity is provided while, in the event of abnormalities, the protective operation using a short-circuit current is appropriately performed through current limiting functions, delayed cutoff functions, and the like of the cooperative autonomous distributed devices (DGRs 40). Furthermore, even if some of the cooperative autonomous distributed devices (DGRs 40) are shut off by the protective operation in the event of a fault, the remaining cooperative autonomous distributed devices (DGRs 40) can continue power distribution to the cell grid system (28). Since the cell grid system (28) is connected to the main grid (15) via the synchronization checking circuit breaker (21), the cell grid system (28) can be connected to the main grid (15) when the main grid (15) and the cell grid system (28) are synchronous, and the cell grid system (28) is unable to be connected to the main grid (15) when the main grid (15) and the cell grid system (28) are not synchronous. The cell grid system (28) can thereby be reliably synchronously connected to the main grid (15). The grid interconnection controller (30) can be implemented in the cloud, for example. The synchronization checking circuit breaker (21) can share part of the grid interconnection controller (30) by obtaining grid voltage information and cell glid voltage information and performing calculations.

When the main grid (15) experiences an outage during grid interconnection, the outage of the main grid (15) can be detected to open the synchronization checking circuit breaker (21) and independently operate the cell grid system (28). For example, in the case of using a high-voltage vacuum circuit breaker (VCB), the rated time delay to switch the synchronization checking circuit breaker (21) from closed to open is 3 to 5 cycles, i.e., 0.06 to 0.1 sec or so. When the main grid experiences an outage during grid interconnection, the cell grid system voltage (Vgrid_mini) can therefore also drop as the main grid voltage (Vgrid_main) drops. This can lead to a so-called black start, where the cell grid system voltage (Vgrid_mini) is started from a state near 0 V, even if the synchronization checking circuit breaker (21) is immediately switched from closed to open upon the outage of the main grid (15) during grid interconnection.

The respective cooperative autonomous distributed devices (DGRs 40) can then be black started using the standard time signals acquired from the standard time signal acquisition devices, e.g., based on standard time signals from GPS clocks (42) or the like. For standard time signals, typical crystal oscillators achieve an accuracy level of ±10 μsec at best, and the errors in the respective cooperative autonomous distributed devices (DGRs 40) can accumulate. The standard time signal acquisition devices need to satisfy an accuracy of within ±5 μsec in time error between the cooperative autonomous distributed devices (DGRs 40).

Examples of standard time signal acquisition methods may include ones including means for precisely correcting time for distance based on the placement of GPS clocks, atomic clocks, or the individual cooperative autonomous distributed devices (DGRs 40), or measuring the zero-crossing of the alternating-current voltage and its time, transmitting the information to the individual cooperative autonomous distributed devices (DGRs 40), and collating the information with the zero-crossing times of the respective cooperative autonomous distributed devices (DGRs 40) to correct the internal clocks.

According to the cooperative autonomous distributed grid interconnection system of the second aspect of the present invention, when the synchronization checking circuit breaker (21) is closed, the cooperative autonomous distributed devices (DGRs 40) can control their power flow and reverse power flow using the inter-grid phase difference signal (ϕglobal). Even if the synchronization checking circuit breaker (21) is open and the information from the grid interconnection controller (MGC 30) is unable to be received, the respective cooperative autonomous distributed devices (DGRs 40) can perform synchronization control on the cell grid system based on the standard time signals. The respective cooperative autonomous distributed devices (DGRs 40) can thus continue independent operation of the cell grid system even in the event of an outage of the main grid, a fault of the grid interconnection controller (MGC 30), a communication failure with the grid interconnection controller (MGC 30), etc.

According to the cooperative autonomous distributed grid interconnection system of the third aspect of the present invention, the phase synchronization signal (Ncyc_ref_Sync) generated by the grid interconnection controller (MGC 30) applying the first standard time signal (t) to the main grid frequency (f) and the main grid rotational phase angle (θref) is transmitted to each cooperative autonomous distributed device (DGR 40). Each cooperative autonomous distributed device (DGR 40) demodulates the cell grid system rotational phase angle signal (θref′) synchronous with the main grid rotational phase angle (θref) by applying the second standard time signal (t′) to the phase synchronization signal (Ncyc_ref_Sync) and the main grid frequency (f). The cell grid system (28) is thereby constantly synchronized with the main grid (15). The cell grid system can thus be connected to and disconnected from the main grid (15) at any time via the synchronization checking circuit breaker (21). In the event of a fault in the main grid (15), the synchronization checking circuit breaker (21) can be opened so that the cell grid system (28) can simply continue supplying power from the power generation facilities within the cell grid system.

According to the cooperative autonomous distributed grid interconnection system according to the fourth aspect of the present invention, the grid interconnection controller (MGC 30) measures the main grid frequency measurement value (f) with the power information about the main grid (15) and/or the power information about the cell grid system (28), such as the main grid voltage, the main grid real power, and the main grid reactive power, as the input, and generates and outputs the inter-grid phase difference signal (ϕglobal) to the cooperative autonomous distributed devices (DGRs 40). The cooperative autonomous distributed devices (DGRs 40) generate the cell grid system phase angle signal (θpll) and the cell grid system angular velocity signal (ωpll) from the cell grid system voltage (Vgrid_mini), and calculates the cell grid system rotational phase angle signal (θref) from the cell grid system phase angle signal (θpll), the cell grid system angular velocity signal (ωpll), the main grid frequency measurement value (f), and the inter-grid phase difference signal (ϕglobal). The frequency and phase of the power converter, such as an inverter, of each cooperative autonomous distributed device (DGR 40) are thereby appropriately controlled to implement synchronization control on the cell grid system (28). According to this aspect, the standard time signals are not necessarily needed since only the voltage information is used.

In the case where the first phase synchronization circuit (96a) measures the main grid frequency measurement value (f) and the second phase synchronization circuit (83) generates the cell grid system phase angle signal (θpll) and the cell grid system angular velocity signal (ωpll), the phase information and the frequency information are generated from the voltage signals by the PLL and the like. Even if a Y-Δ converter is connected to a cooperative autonomous distributed device (DGR 40) with a phase shift of 30° or when the impedance connected to a cooperative autonomous distributed device (DGR 40) is high and the phase shifts, the issues of the phase differences are solved since the phase information and the frequency information are based on the voltage signals themselves. Moreover, when the PLL and the like generate the phase information and frequency information from the voltage signals, or detected voltages, the protective functions required of an islanding detection protection device are easy to comply since the cooperative autonomous distributed devices (DGRs 40) always operate based on the voltage signals.

According to the cooperative autonomous distributed grid interconnection system of the fifth aspect of the present invention, the first phase synchronization circuit (96a) and the second phase synchronization circuit (83) regularly use the standard time signals from the standard time acquisition device. For example, it is sufficient to synchronize the PLL clocks and the like using the standard time signals at a frequency of, e.g., once per second or so. Since the standard time signals are not constantly needed, the calculation load is reduced accordingly while the PLL clocks of the respective cooperative autonomous distributed devices (DGRs 40) can be constantly synchronized.

Moreover, since the respective cooperative autonomous distributed devices (DGRs 40) are synchronized, the cell grid system (28) can be black started. The respective cooperative autonomous distributed devices (DGRs 40) can remain synchronized even when the signals from the grid interconnection controller (MGC 30) are not available, such as when the inter-grid phase signal is not available during a fault of the grid interconnection controller (MGC 30) and ϕglobal=0, in the event of a fault of the grid interconnection controller (MGC 30), and in the event of a communication failure with the grid interconnection controller (MGC 30). If the main grid frequency measurement value is not available from the grid interconnection controller (MGC 30), the cell grid system can continue independent operation by the respective cooperative autonomous distributed devices (DGRs 40) generating a fixed signal equivalent to the main grid frequency value, for example, f=50 Hz in cases where the main grid frequency is 50 Hz.

According to the cooperative autonomous distributed grid interconnection system of the sixth aspect of the present invention, if the cell grid is a pass-through system and an abnormality occurs in the first main grid (15a), the cell grid system can not only continue supplying power by itself but also continue grid interconnection with the normal second main grid. In addition, the cell grid system can transmit power to the abnormality-free area (15a1) within the service area of the substation included in the first main grid. In such a case, the cell grid system (28) can transmit the power from the normal second main grid (15b) to the abnormality-free area (15a1) within the service area of the substation included in the first main grid (15a).

### (Response Procedures for Main Grid Outages and Cell Grid System Faults)

According to the cooperative autonomous distributed grid interconnection system of the seventh aspect of the present invention, when the main grid (15) experiences an outage with the cell grid system (28) interconnected with the main grid (15), the cell grid system (28) can be independently operated to continue supplying power from the power facilities within the cell grid system. If a fault occurs in the cell grid system during the independent operation of the cell grid system (28), the synchronization checking circuit breaker (21) can be closed to supply a short-circuit current from the main grid (15) to the fault point and trigger the protective relay at the fault point to disconnect the fault point. The power supply to the normal portions within the cell grid system can thereby be continued.

According to the grid interconnection method of the cooperative autonomous distributed grid interconnection system of the eighth aspect of the present invention, the motherboard (123) can perform all the control calculations including the pulse wave generation of the one or more individual units (130). With the common unit (120) commonized and the board-to-board interfaces standardized, the individual units (120) can be provided as various application products. All the system operations can be implemented in the cloud by the grid interconnection controller (MGC 30). Moreover, by the grid interconnection controller (MGC 30) updating the software of the motherboard via the cloud, the latest software can always be used.

According to the grid interconnection method of the cooperative autonomous distributed grid interconnection system of the ninth aspect of the present invention, the pulse waves for all the individual units (130) can be appropriately calculated through the hysteresis control by the motherboard (123).

According to the grid interconnection method of the cooperative autonomous distributed grid interconnection system of the tenth aspect of the present invention, a grid interconnection method that provides effects similar to those of the cooperative autonomous distributed grid interconnection system according to the first aspect can be provided.

According to the program of the eleventh aspect of the present invention, a program that provides effects similar to those of the cooperative autonomous distributed grid interconnection system according to the first aspect can be provided.

### BRIEF DESCRIPTION OF DRAWINGS

FIG. 1 is a block diagram of a cooperative autonomous distributed grid interconnection system according to Embodiment 1 of the present invention.

FIG. 2A is a circuit diagram of a cooperative autonomous distributed device.

FIG. 2B is a detailed circuit diagram of FIG. 2A.

FIG. 2C is an explanatory operation diagram of FIG. 2B.

FIG. 2D is a circuit diagram of the cooperative autonomous distributed grid interconnection system according to Embodiment 1 of the present invention.

FIG. 2E is an explanatory diagram of rotational phase angles of FIG. 2D.

FIG. 2F is an explanatory diagram of the rotational phase angles of FIG. 2D after adjustment.

FIG. 3A is a block diagram of synchronization control with GPS synchronization according to Embodiment 1 of the present invention.

FIG. 3B is a control block diagram of a main grid connected state with GPS synchronization according to Embodiment 1 of the present invention.

FIG. 3C is a control block diagram of a cell grid system independent state (synchronization control) with GPS synchronization according to Embodiment 1 of the present invention.

FIG. 3D is a control block diagram of a cell grid system independent state (during a main grid outage) with GPS synchronization according to Embodiment 1 of the present invention.

FIG. 4A is a control block diagram of a main grid connected state with voltage synchronization according to Embodiment 1 of the present invention.

FIG. 4B is a control block diagram of a cell grid system independent state (synchronization control) with voltage synchronization according to Embodiment 1 of the present invention.

FIG. 4C is a control block diagram of a cell grid system independent state (during a main grid outage) with voltage synchronization according to Embodiment 1 of the present invention.

FIG. 5A is an explanatory diagram of a first state of cell grid connection according to Embodiment 2 of the present invention.

FIG. 5B is an explanatory diagram of a second state of the cell grid connection according to Embodiment 2 of the present invention.

FIG. 5C is an explanatory diagram of a third state of the cell grid connection according to Embodiment 2 of the present invention.

FIG. 5D is an explanatory diagram of a fourth state of the cell grid connection according to Embodiment 2 of the present invention.

FIG. 5E is an explanatory diagram of a fifth state of the cell grid connection according to Embodiment 2 of the present invention.

FIG. 5F is an explanatory diagram of a sixth state of the cell grid connection according to Embodiment 2 of the present invention.

FIG. 5G is an explanatory diagram of a seventh state of the cell grid connection according to Embodiment 2 of the present invention.

FIG. 5H is an explanatory diagram of an eighth state of the cell grid connection according to Embodiment 2 of the present invention.

FIG. 5I is an explanatory diagram of a ninth state of the cell grid connection according to Embodiment 2 of the present invention.

FIG. 5J is an explanatory diagram of a tenth state of the cell grid connection according to Embodiment 2 of the present invention.

FIG. 5K is an explanatory diagram of an eleventh state of the cell grid connection according to Embodiment 2 of the present invention.

FIG. 5L is an explanatory diagram of a twelfth state of the cell grid connection according to Embodiment 2 of the present invention.

FIG. 5M is an explanatory diagram of a thirteenth state of the cell grid connection according to Embodiment 2 of the present invention.

FIG. 5N is an explanatory diagram of a fourteenth state of the cell grid connection according to Embodiment 2 of the present invention.

FIG. 6 is a block diagram of a cooperative autonomous distributed grid interconnection system according to Embodiment 3 of the present invention.

### DESCRIPTION OF EMBODIMENTS

Cooperative autonomous distributed grid interconnection systems according to embodiments of the present invention will be described below with reference to the drawings. Note that the following embodiments are examples of cooperative autonomous distributed grid interconnection systems for materializing the technical concept of the present invention, and the present invention is not limited thereto. The present invention is equally applicable to other embodiments that fall within the scope of the claims.

### Embodiment 1

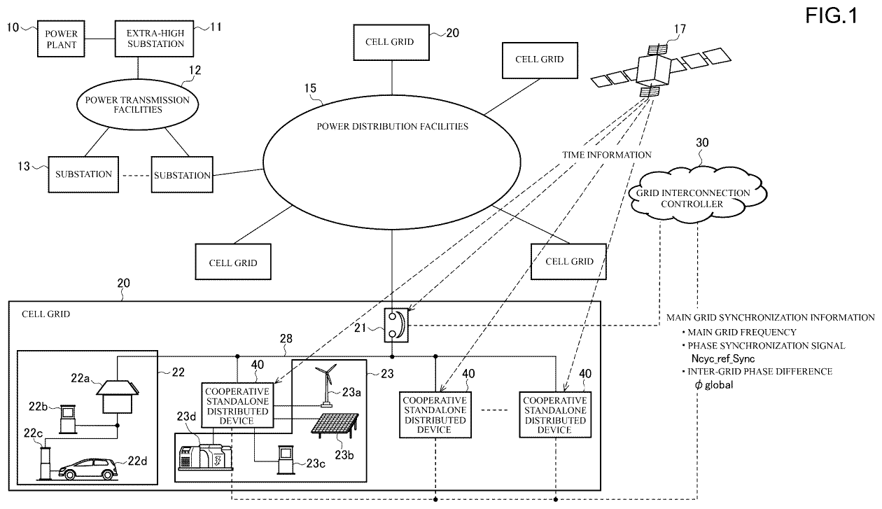

A cooperative autonomous distributed grid interconnection system according to Embodiment 1 of the present invention will be described with reference to FIGS. 1 to 4C. FIG. 1 is a block diagram of the cooperative autonomous distributed grid interconnection system according to Embodiment 1 of the present invention.

### [Overall Configuration of Cooperative Autonomous Distributed Grid Interconnection System]

Power generated at a power plant 10 is stepped up to an extra-high voltage at an extra-high voltage substation 11. The power is further stepped down at a substation 13 via power transmission facilities 12 and supplied to main power distribution facilities 15 (hereinafter, referred to as a “main grid”). A plurality of cell grids 20 is connected to the main grid 15. The power distributed to the main grid 15 is not limited to high voltage (alternating-current voltage higher than 600 V and lower than or equal to 7,000 V), but may be extra-high voltage (alternating-current voltage higher than 7,000 V) or low voltage (alternating-current voltage lower than or equal to 600 V), for example.

In a power distribution system (hereinafter, referred to as a “cell grid”) disconnected at least at one location by a synchronization checking circuit breaker 21 capable of disconnecting the main power distribution system (hereinafter, referred to as a “main grid”), a cell grid 20 includes the synchronization checking circuit breaker 21, a cell grid system 28 connected to the main grid 15 via the synchronization checking circuit breaker 21, cooperative autonomous distributed devices 40 (hereinafter, may be referred to as digital grid routers [DGRs]) having one or more power conversion functions, and various power facilities connected to the cell grid system 28. A cell grid 20 may be a power network having a scale equivalent to a residential complex, a city block, or an industrial complex or industrial park, for example, and refers to a power network that enables local production and consumption of electricity from distributed power sources such as natural energy power generation facilities within the region, without depending on electricity from large-scale nuclear power plants or thermal power plants outside the region. Cell grids are often referred to as “micro-grids” in Japan, and may be called “mini-grids” in this English specification. These expressions are used synonymously with cell grids 20. A grid interconnection controller 30 may be abbreviated as “MGC” (Mini Grid Controller).

Assume a residential complex for a single cell grid 20. For example, 52% of residential complexes in Japan have a complex area of 100 ha or more (“The Current Status of Residential Complexes [Juutaku Danchi No Jittai Ni Tsuite]” the Ministry of Land, Infrastructure, Transport and Tourism Housing Bureau, December 2018). A single cell grid 20 may be 100 ha or more in scale, and can be applied to residential complexes of any size by increasing or decreasing the number of DGRS 40.

A DGR 40 can be connected with various distributed power sources as power generation facilities 23. Examples of the power generation facilities 23 include a wind power generation apparatus 23a, a solar power generation apparatus 23b, a fuel cell apparatus, a hydrogen power generation apparatus, a bio power generation apparatus, an internal combustion engine power generation apparatus (such as diesel and gas engines) 23d, a gas turbine power generation apparatus, a geothermal power generation apparatus, and a hydroelectric power generation apparatus (for example, 200 kW or so). Power equipment such as storage batteries 22b and 23c and an electric vehicle charger/discharger 22c can also be connected to the DGR 40. The DGR 40 includes a power converter such as an inverter. For example, the DGR 40 can convert a direct-current voltage generated by the solar power generation apparatus 23b into an alternating-current voltage and supplies the alternating-current voltage to the cell grid system 28.

The cell grid system 28 distributes power to household facilities 22a serving as power demand facilities 22. The power demand facilities 22 are not limited in particular, and examples may include the household facilities 22a, the storage battery 22b, the electric vehicle charger/discharger 22c, and an electric auto 22d. The storage battery 22b, the electric vehicle charger/discharger 22c, and the electric auto 22d are capable of charging and discharging, and thus function as power demand facilities 22 during charging and power generation facilities 23 during discharging. While the storage battery 22b, the electric vehicle charger/discharger 22c, and the electric auto 22d are shown as the power demand facilities 22 in FIG. 1, the present embodiment is not limited thereto and these devices may be connected to a cooperative autonomous distributed device 40 as power generation facilities 23.

The power generation facilities 23 such as the wind power generation apparatus 23a, the solar power generation apparatus 23b, and the internal combustion engine power generation apparatus 23d, and the storage battery 23c, etc., are connected to the cell grid system 28 via a DGR 40. As will be described below, the DGRs 40 perform synchronization control on the cell grid system 28 to synchronize with the frequency and phase of the main grid 15, based on a main grid frequency measurement value f, a phase synchronization signal Ncyc_ref_Sync, and the like transmitted from the MGC 30 implemented in the cloud. Moreover, the flow or reverse flow of both real power and reactive power can be controlled by adjusting an inter-grid phase difference ϕglobal between the main grid 15 and the cell grid system 28. More specifically, when the cell grid system 28 receives power from the main grid 15, i.e., the cell grid system receives power flow, the power flow from the main grid to the cell grid system can be increased by reducing the inter-grid phase difference ϕglobal. On the other hand, when, for example, the power generation facilities 23 in the cell grid 20, such as the solar power generation apparatus, transmit generated surplus power to the main grid 15, i.e., in the case of reverse power flow, the amount of power transmitted to the main grid 15 can be increased by increasing the inter-grid phase difference ϕglobal to advance the phase angle of the cell grid system 28.

The synchronization checking circuit breaker (DG breaker) 21 can connect the cell grid system 28 to the main grid 15 when the main grid 15 and the cell grid system 28 are synchronous, and is unable to connect the cell grid system 28 to the main grid 15 when the main grid 15 and the cell grid system 28 are not synchronous. The synchronization checking circuit breaker 21 thus includes a PLL, and can detect a phase difference between the main grid 15 and the cell grid system 28. The synchronization checking circuit breaker 21 can be closed only when the two grids are synchronous. In other words, synchronization check can be performed by the PLL.

The synchronization checking circuit breaker 21 can detect the main grid frequency f and a main grid rotational phase angle θref. The synchronization checking circuit breaker 21 includes the PLL, and can detect the phase difference between the main grid 15 and the cell grid system 28. The main grid frequency f, the main grid rotational phase angle θref, and the phase difference between the main grid 15 and the cell grid system 28 detected by the synchronization checking circuit breaker 21 are transmitted to the DGRs 40 and used for phase synchronization control. In such a manner, the synchronization checking circuit breaker (21) can assume part of the grid interconnection controller (30) by obtaining grid voltage information and cell grid voltage information and performing calculations.

While an example where the synchronization checking circuit breaker 21 includes the main grid frequency f, the main grid rotational phase angle θref, and the PLL is described here, the present embodiment is not limited thereto. The detectors of the main grid frequency f and the main grid rotational phase angle θref may be provided separate from the synchronization checking circuit breaker 21. The PLL may also be provided separate from the synchronization checking circuit breaker 21.

Since a plurality of DGRs 40 are distributed within the cell grid system 28, the coverage of a single DGR 40 can be small. This provides advantages such as shorter distribution lines and smaller wire diameters, since large-scale grid interconnection facilities do not need to be disposed within the cell grid system 28 in a centralized manner. The coverage of a single DGR 40 is not limited in particular. For example, approximately ten residential houses can be covered as a unit. In such a case, the DGR 40 may have, but not particularly limited to, a DC input of 750 V and 40 kW, for example, and an AC output of 380 V and 40 kW in three phases, for example, with one to four built-in batteries with a capacity of 20 kWh. Smaller DGRs may have a DC input of 350 V and 20 kW, for example, and an AC output of 200 V and 20 kW in three phases, for example, with one to four built-in batteries with a capacity of 20 kWh.

When the main grid and the cell grid system are not connected, the system according to the present embodiment informs all the DGRs 40 within the cell grid of the frequency and phase of the main grid using a technique to be described below, whereby the frequency and phase of the cell grid are synchronized. When the main grid and the cell grid system are connected, the system according to the present embodiment controls the power flow between the grids. Moreover, when the main grid and the cell grid system are connected and the voltage of the main grid falls for a short time, the system according to the present embodiment can maintain synchronization (Fault Ride Through: FRT). In the event of an outage of the main grid, the system according to the present embodiment can disconnect and black start the cell grid. The magnitude of voltage is information closely related to the reactive power, and is thus also communicated to all the DGRs 40 within the cell grid. The communication technique is an existing technique, and therefore will not be described in detail. Consequently, during constant voltage operation, the power flow and reverse power flow of the power generation facilities 23 connected to the cell grid system 28, such as renewable energy power generation facilities, can be controlled to enable local production and consumption of power generated by the power generation facilities 23 within the cell grid system 28. In the event of an outage of the main grid 15, standalone operation can be made.

The MGC 30 controls the respective DGRs 40 within the cell grid 20 in a comprehensive manner, and performs interconnected control on the total power demand of the cell grid 20 and the amounts of power generation, phases, and frequencies of the power generation facilities 23, fault control, grid outage/restoration control, demand schedule control, etc.

Synchronization control on each DGR 40 is performed using accurate time information, for example, GPS-based time information using an artificial satellite 17. Moreover, the MGC 30 transmits information such as the main grid frequency f, the phase synchronization signal Ncyc_ref_Sync, and the inter-grid phase difference ϕglobal to each DGR 40 as main grid synchronization information.

### [Equivalent Circuit of DGRs 40 in Cell Grid]

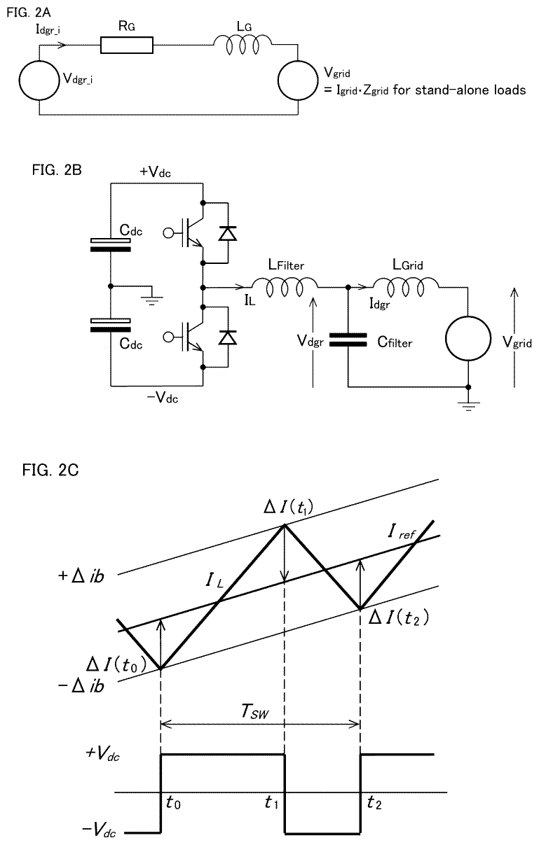

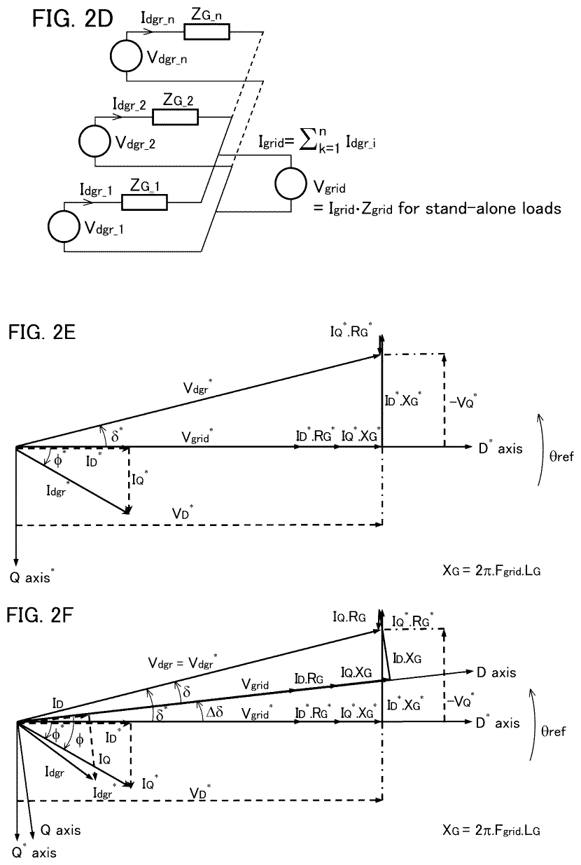

FIGS. 2A to 2F are principle diagrams of the cooperative autonomous distributed grid interconnection system according to Embodiment 1 of the present invention. FIG. 2A is a circuit diagram of a cooperative autonomous distributed device 40, showing an equivalent circuit where a single DGR 40 in the cell grid system 28 is extracted. As shown in FIG. 2A, all the DGRs 40 operate as an alternating-current voltage source Vdgr_i with output impedance. The suffix i indicates the number of DGRs 40. Each DGR 40 is connected to a cell grid voltage Vgrid in parallel via a grid interconnection resistance RG and an inductance LG. A current Idgr_i flows out from each DGR 40. Since the cell grid voltage Vgrid is common for all the DGRs 40, each DGR 40 can control Idgr_i by changing its internal voltage Vdgr_i. In a normal state, Idgr_i is controlled to be the same for all i's to enable equal load sharing between the DGRs 40. However, Idgr_i can be controlled to flow into a DGR 40 to change the load sharing depending on the state of the DGR 40, or charge the internal storage battery. Such control can be implemented through settings of Vdgr_i target values.

### [Vdgr Voltage Control by Current Hysteresis Control]

FIG. 2B is a detailed circuit diagram of FIG. 2A, showing a half-bridge inverter that is a component of the DGR 40. FIG. 2C is an explanatory operation diagram of FIG. 2B, showing how IL increases and decreases repeatedly as the upper and lower switches of the half-bridge turn on alternately. Upper and lower band widths are set for a target current value Iref. When a measured current value IL exceeds the upper band, the upper switch of the half-bridge is turned off and the lower switch is turned on. When the measured current value IL falls below the lower band, the lower switch is turned off and the upper switch is turned on. The repetition of such an operation is referred to as current hysteresis control. Details of the hysteresis control will be described below in Embodiment 3.

In general, a challenge with hysteresis control is variations in the switching cycle, which make filter design and the like difficult. In the present invention, a variable band width method has been devised to solve this problem. The lines above and below the target current value Iref in FIG. 2C represent the bands. Narrowing the band widths accelerates the switching cycle. Widening the band widths slows the switching cycle. Since the gradient of the reactor current IL of the half-bridge changes with a difference between Vdc and Vdgr, the band widths are changed based on the difference so that the switching frequency remains substantially constant. Open-loop control is thereby performed so that the target current value Iref matches Idgr and the filter voltage of the half-bridge matches the target Vdgr. This consequently enables high-speed voltage control, whereas the control target is a current. The following description is predicated on Vdgr being directly controlled by such a method.

FIG. 2D is a circuit diagram of the cooperative autonomous distributed grid interconnection system according to Embodiment 1 of the present invention, showing a state where N DGRs 40 shown in FIG. 2A are connected in parallel in the cell grid. FIG. 2D shows the state where the cell grid voltage Vgrid is common and the DGRs 40 are connected thereto via respective different output impedances ZG_i (i=1 to N) with different voltages Vdgr_i to pass respective currents Idgr_i. Since parallel connection and operation of multiple voltage sources like this produces cross-currents between the voltage sources unless voltage synchronization is achieved with high precision, synchronizing force has been considered crucial. The present invention employs means using a standard time signal as the synchronization signal. In the present embodiment, a virtual impedance technique to be described below is further used to virtually equalize ZG_i, whereby Vdgr_i and Idgr_i are made equal for uniform load sharing. By controlling Vdgr, Idgr can be changed to change the load shares between the DGRs 40.

The physical output impedances of the DGRs 40 vary depending on factors such as the installation locations, the effects of the outlet transformers, and the distances and wire thicknesses of the distribution lines. Since these values are not known in advance, the load sharing ratios are difficult to equalize between the plurality of DGRs 40 even by operating the internal voltages Vdgr of the DGRs 40. One effective solution is to introduce virtual impedances to increase the ratios of known impedances. The load sharing ratios can be equalized more easily by defining virtual impedances including the physical impedances, making the values the same between the DGRs 40, and taking the values into consideration for Vdgr control.

Specifically, such control is implemented by subtracting the voltage drop due to the virtual impedance (=(virtual reactor−physical reactor)×time derivative of Idgr) from the control target value of Vdgr. For example, the setting value of the virtual impedance is determined so that the voltage drops by 15% or so of the rated voltage when the rated current is passed, with the physical impedance included. It is therefore important to accurately determine the physical impedances of the DGRs 40 at the respective installation locations and incorporate the physical impedances as control constants.

The following two synchronization techniques are employed to synchronize the frequencies and phases of all the DGRs 40 within the cell grid. The two techniques are a synchronization technique (A) based on the GPS time signal and a voltage-based synchronization technique (B). The two techniques are complementary to each other, and can be used in combination or singly. All the DGRs 40 include GPS receivers as means for inputting the standard time signal. However, the means are not limited to GPS as long as the accuracy of the standard time signal is ensured. When the GPS signal is interrupted, the voltage-based synchronization technique (B) enables all the DGRs 40 to operate synchronously without the standard time signal. Both techniques detect frequency and phase from a voltage vector by using a well-known technique called phase lock loop (PLL). The two synchronization techniques will now be described in detail. As for reactive power, voltage correction information is transmitted to all the DGRs 40 via the MGC 30, so that the reactive power can be adjusted using a conventional PI control technique or the like. The synchronization technique using the GPS time signal (A) will initially be described.

### Description of (A) Synchronization Technique Using GPS Time Signal

FIG. 2E shows the mutual relationship between the current Idgr of a DGR 40, the internal voltage phase Vdgr of the DGR 40, and the cell grid voltage phase Vgrid under GPS time synchronization control. The superscript “*”, like Vgrid*, indicates a target value. FIG. 2E shows a state where the targets and the actual values are the same. In the following description, the values are expressed as actual values. Vgrid is based on the GPS time signal and thus synchronized across all the DGRs 40. Vgrid rotates at the speed of the frequency based on a global angle reference θref calculated from the GPS time reference. In FIG. 2E, Vgrid is expressed as a fixed D-axis. Idgr is a current lagging at a phase angle ϕ based on the load in the cell grid and the grid impedance. Idgr is decomposed into ID and IQ on the D- and Q-axes. ID is in phase with Vgrid, and IQ is a 90°-lagging component.

Idgr and the virtual impedance including the foregoing physical impedance cause a voltage drop on the D- and Q-axes. The voltage drop in the D-axis component is ID×RG+IQ×XG. The voltage drop in the Q-axis component is ID×XG−IQ×RG. In FIGS. 2E and 2F, the multiplication symbol “x” is represented by “.”. Since the voltage drops in the D- and Q-axis components constitute the voltage drop between Vdgr and Vgrid, Vdgr is determined to compensate for the voltage drop. The phase angle to arise between the internal voltage Vdgr and the cell grid system voltage Vgrid here is denoted by δ. Since Vgrid is synchronized across all the DGRs 40, Vdgr also rotates synchronously but with a phase difference. Adjusting the phase angle δ can thus change the output shares between the DGRs 40, or produce a negative output for charging the built-in storage battery, i.e., so that the DGR 40 functions as a load.

In the GPS time synchronization technique, when the cell grid is in connection with the main grid, the target Vgrid* vector is generated based on the frequency of the main grid. The internal voltage target Vdgr* and the current target Idgr* of the DGR 40 are also determined as shown in FIG. 2E based on the virtual impedance. The actual cell grid voltage Vgrid and the actual internal voltage Vdgr and current Idgr of the DGR 40 are also controlled to converge to and are substantially the same as the respective target values Vgrid*, Vdgr*, and Idgr*. Any power surplus or deficit resulting from an imbalance between the total output of all the DGRs 40 and the total demand within the cell grid is supplied from the main grid or flows back toward the main grid.

By contrast, when the cell grid is disconnected from the main grid and operating independently, there is no power adjustment by the main grid, and the total output of all the DGRs 40 and the total demand within the cell grid need to be exactly the same. Since the DGRs 40 do not have demand information, the actual Vdgr is controlled to match the target internal voltage Vdgr* of each DGR 40. Consequently, as shown in FIG. 2F, the actual current Idgr corresponding to the actual demand flows. By these actual Vgrid and actual Idgr, the real power component and reactive power component of the demand are supplied without a surplus or deficit. As a result, the actual current Idgr and the target current value Idgr* deviate from each other. The actual voltage Vgrid also deviates from the target Vgrid*. The phase difference between the actual cell grid voltage Vgrid and the target cell grid voltage Vgird* is denoted by Δδ. Since the D-axis* is synchronous with the frequency of the main grid, to transition the cell grid from the independent operation to interconnected operation, it is sufficient to bring this Δδ close to 0 for synchronization with the main grid. To achieve this, the signal ϕglobal to be described below is used.

To synchronize all the DGRs 40, accurate standard time needs to be applied. When a synchronization error occurs, voltage differences arise between the DGRs 40. Since the impedance between the DGRs 40 causes a voltage drop of 10% to 20%, the control error of the current adds up to ±10% to ±5% or so even with an allowable voltage error of 18. The voltage error is therefore desirably reduced as much as possible. The voltage error of 1% is equivalent to a phase angle of 0.0015 radians. In terms of time, this is equivalent to an accuracy of 5 μsec. There are crystal oscillators with an accuracy of ±10 μsec or so, but the error between the DGRs 40 will increase without common correction. A common time signal that ensures this level of accuracy and is relatively inexpensively available is the GPS time signal. Radio clocks and Network Time Protocol do not have sufficient accuracy. Atomic clocks, though expensive, are also an option.

Examples of a standard time signal acquisition device according to the present invention include standard time signal acquisition methods including means for precisely correcting time for distance based on the placement of GPS clocks, atomic clocks, or the individual cooperative autonomous distributed devices (DGRs 40), or measuring the zero-crossing of the alternating-current voltage and its time, transmitting the information to the individual cooperative autonomous distributed devices (DGRs 40), and collating the zero-crossing times of the respective cooperative autonomous distributed devices (DGRs 40) with the information to correct the internal clocks.

### [(A) Block Diagram of Synchronization Control]

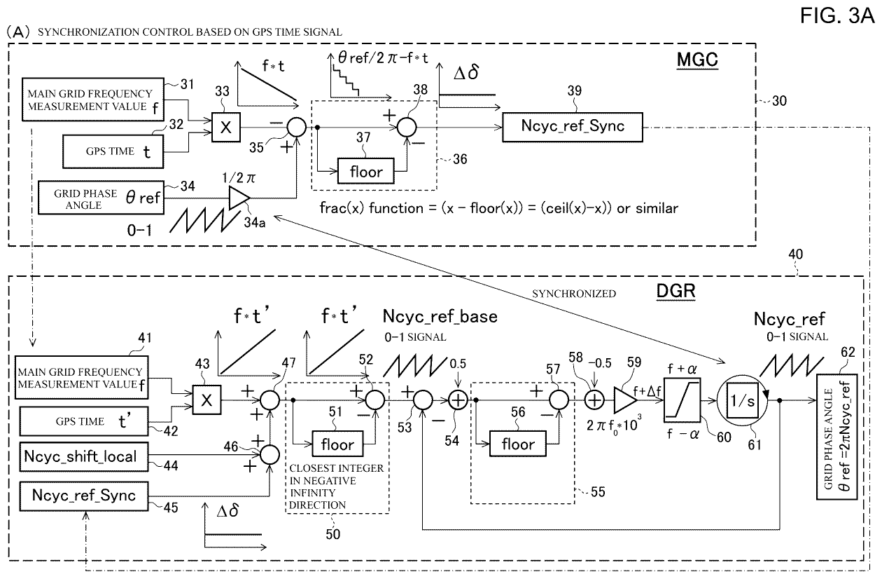

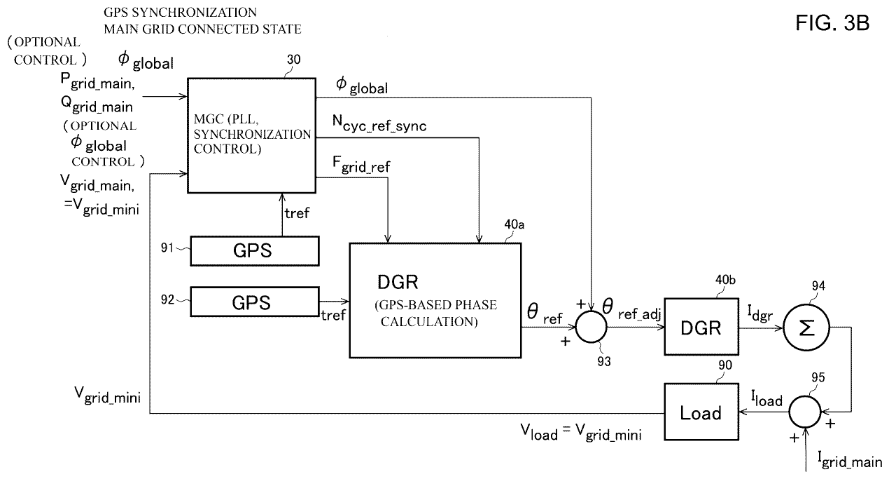

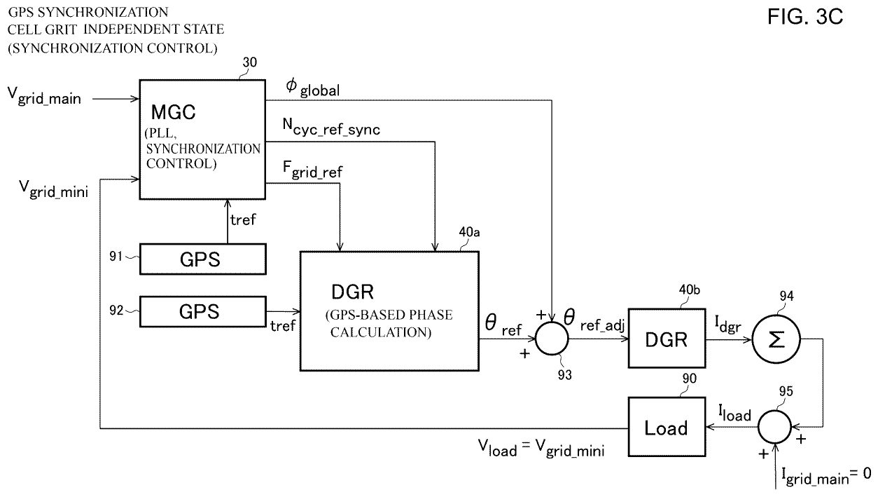

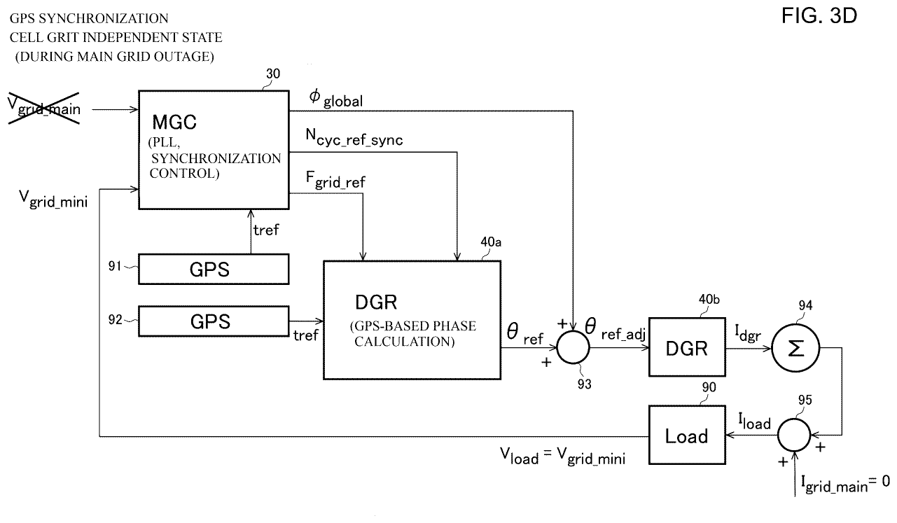

FIG. 3A is a block diagram of synchronization control with GPS synchronization according to Embodiment 1 of the present invention. The synchronization control method based on the GPS time signal will be described with reference to FIG. 3A. This method is characterized in that each DGR 40 can generate a phase angle signal θref synchronous with the main grid within ±5 μsec by receiving via the MGC 30 two signals, namely, the main grid frequency signal f and the phase synchronization signal Ncyc_ref_Sync obtained by the application of the GPS time signal and combining the two signals with the GPS time signal inside the DGR 40. Details will now be described.

In the calculation blocks of FIG. 3A, the grid interconnection controller (MGC) 30 performs calculations as follows: A main grid frequency measurement device 31 measures the main grid frequency f. A first time acquisition unit acquires GPS time t 32 as first time information (t). The two are multiplied, and subtracted from a main grid rotational phase angle θref 34 that is sawtooth-shaped for each cycle. The result is subjected to a “function for extracting the fractional part” to be described below, such as the floor function, whereby a phase synchronization signal Ncyc_ref_Sync 39 (equivalent to Δδ) can be calculated. The MGC 30 transmits the two signals, or the main grid frequency signal f and the phase synchronization signal Ncyc_ref_Sync, to each DGR 40. The means of transmission can be server-based or broadcast-based. The foregoing calculation units are internal functions of the MGC 30, but may be physically built in the synchronization checking circuit breaker 21 and used for calculation, and the two signals may be transmitted to each DGR 40 via the cloud using mobile lines or by power line communication.

As for the function for extracting the fractional part, the floor function may be replaced with the frac function, the ceil function, the round function, the MOD function, or the like. The two signals, namely, the main grid frequency signal f and the phase synchronization signal Ncyc_ref_Sync, change gently, and can thus be treated substantially as constants compared to the calculation speed and the signal transmission time from the MGC 30 to the DGRs 40. A communication rate of 0.1 sec to 10 sec or so is allowed between the MGC 30 and the DGRs 40.

In the calculation blocks of FIG. 3A, the cooperative autonomous distributed device (DGR) 40 performs calculations as follows: A main grid frequency measurement value acquisition unit 41 of the DGR 40 initially receives the main grid frequency f acquired from the synchronization checking circuit breaker 21 by the grid interconnection controller (MGC) 30. From a second time acquisition unit, second time information (t′) is acquired as GPS time t′ 42. Each DGR 40 includes Ncyc_shift_local 44 in a case where an adjustment value specific to the installation location of the DGR 40 is needed. The DGR 40 receives Ncyc_ref_Sync 39 calculated by the MGC 30 and uses it as Ncyc_ref_Sync 45 inside the DGR 40.

Next, a multiplier 43 multiplies the main grid frequency measurement value f 41 and the GPS time t′ 42, whereby f·t′ is obtained as a graph with a continuously increasing characteristic. Adders 46 and 47 add Ncyc_shift_local 44 and Ncyc_ref_Sync 45 to this f·t′, and a subtractor 52 performs calculation 50 for subtracting the output of a floor function 51 from the sum, whereby Ncyc_ref_bas is obtained as a sawtooth-shaped graph. This calculation 50 using the floor function is not restrictive. For example, the calculation 50 may be replaced with other functions for extracting the fractional part as described above.

The DGR 40 includes a subtractor 53 that subtracts Ncyc_ref for feedback after the operation 50 using the frac function. After a value of 0.5 is added by an adder 54, calculation 55 using the frac function is performed. In FIG. 3A, the calculation 55 using the frac function includes a subtractor 57 subtracting the output of a floor function 56. However, the present embodiment is not limited thereto. For example, the operation 55 may be replaced with a function for extracting the fractional part as described above. An adder 58 then performs calculation for adding a value of −0.5, and a multiplier 59 further performs the following calculation:

f=2πf0·10³ (1)

to calculate f+Δf. After f is passed through a limiter 60 of f−α and f+α for f, Ncyc_ref is demodulated by calculation of an integrator 61. Through these operations, the grid phase angle θref 34 of the main grid 15 and an output grid phase angle θref 62 of each DGR 40 are synchronized in phase, and the frequencies are also made the same.

The input signal of the limiter 60 is f+Δf, i.e., the sum of the frequency and the rate of change of frequency (ROCOF). The provision of the limiter 60 for the rate of change portion implements a factor for determining the speed and magnitude of phase tracking in the cell grid. More specifically, if the width of the limiter 60 is widened, the cell grid follows phase changes of the main grid quickly but with somewhat large phase fluctuations. If the width of the limiter 60 is narrowed, the cell grid takes time to follow phase changes of the main grid but with small phase fluctuations.

The presence of the transmission delay in the frequency and phase tracking by the MGC 30 and the limitation by the limiter 60 have the effect of suppressing the rate of change of frequency (ROCOF) within a certain range. This mechanism has extremely high stability since a first-order transfer function is used instead of a second-order transfer function simulating the synchronous machine of a typical grid forming inverter. Note that while the main grid rotational phase angle θref is originally a signal ranging between 0 and 2π, the main grid rotational phase angle θref here is divided by 2π and handled as a sawtooth-shaped signal ranging between 0 and 1.

The blocks from the subtractor 53 to the integrator 61 have the role of a low-pass filter, and serve to remove noise included in Ncyc_ref_bas, such as whisker-like noise. However, the present embodiment is not limited to these blocks, and can be configured to perform discrete time control using 1/Z-transform, for example.

### [(A) Description of Grid Interconnection, Independent Operation, and Main Grid Outage States]

Next, referring to FIGS. 3B, 3C, and 3D, the following three states will be described.
Main grid connected state: FIG. 3B is a control block diagram of a main grid connected state with GPS synchronization according to Embodiment 1 of the present invention.
Cell grid independent state: FIG. 3C is a control block diagram of a cell grid system independent state (synchronous control) with GPS synchronization according to Embodiment 1 of the present invention.
Main grid outage, cell grid independent operation state: FIG. 3D is a control block diagram of a cell grid system independent state (during a main grid outage) with GPS synchronization according to Embodiment 1 of the present invention.

### [(A) Main Grid Connected State]

In FIG. 3B, the synchronization checking circuit breaker 21 is closed, and the main grid 15 and the cell grid system 28 are synchronized and interconnected. A main grid voltage Vgrid_main is thus the same as a cell grid system voltage Vgrid_mini. Main grid real power Pgrid_main and main grid reactive power Qgrid_main are input to the MGC 30, and the MGC 30 calculates the inter-grid phase difference signal ϕglobal. In the grid interconnected state, ϕglobal controls the flows of the real power and the reactive power between the two grids. ϕglobal of respective different values can be transmitted to the DGRs 40 without changing the total sum, so that the DGRs 40 provide respective different outputs.

GPS time information tref serving as the first time information (t) is input to the MGC 30 from a GPS receiver 91 serving as the first time acquisition unit. Meanwhile, tref serving as the second time information (t′) is input to a DGR 40a from a GPS receiver 92 serving as the second time acquisition unit.

The MGC 30 calculates the phase synchronization signal (Ncyc_ref_Sync), and transmits and inputs two pieces of information, namely, a main grid frequency and Fgrid_ref to the DGR (GPS-based phase calculation block) 40a. While the two pieces of information are sufficient for synchronization control, the ϕglobal signal is also transmitted for power flow control. The DGR 40a calculates the cell grid system rotational phase angle θref of the DGR 40. An adder 93 adds θref and ϕglobal to calculate θref adj. A DGR 40b is operated based on θref adj, and an output current Idgr of each DGR 40 is output. The output currents of the respective DGRs 40 are added to flow through the cell grid (in FIG. 3B, represented by an adder 94). The resulting current is supplied to a cell grid system load 90 along with an inflow current Igrid_main from the main grid. As a result, the cell grid system voltage Vgrid_mini (=cell grid system load voltage Vload) is established. This voltage is input to the MGC 30 to form a stable feedback loop.

### [(A) Cell Grid Independent State (During Main Grid Operation)]

With reference to FIG. 3C, a phase synchronization method between the two grids when the synchronization checking circuit breaker 21 is opened to disconnect the main grid 15 and the cell grid system 28 and the cell grid is in an independent operation state will be described. With the two grids disconnected, the main grid voltage Vgrid_main is typically different from the cell grid system voltage Vgrid_mini. However, in this GPS time synchronization method, θref's of both grids are constantly synchronized by the transmission of the main grid frequency f 31 and the phase synchronization signal Ncyc_ref_Sync 39 and the calculations of FIG. 3A. During independent operation, the inter-grid phase difference signal ϕglobal can be used for fine adjustment. Since the voltage phase of the cell grid system 28 is thus synchronized with that of the main grid 15, the cell grid system 28 can be connected to the main grid 15 by closing the synchronization checking circuit breaker 21 at any time.

### [(A) Cell Grid Independent State (During Main Grid Outage)]

FIG. 3D shows how to synchronize the DGRs 40 within the cell grid with GPS synchronization according to Embodiment 1, where the main grid is experiencing an outage and the cell grid system is in an independent state (during a main grid outage). When the main grid is down, the synchronization checking circuit breaker turns off and the information from the MGC 30 is lost. Meanwhile, tref serving as the second time information (t′) continues to be input to the DGR 40a from the GPS receiver 92 serving as the second time acquisition unit.

All the DGRs 40 can thus obtain θref synchronized with the GPS time as the common index by all the DGRs 40 replacing the main grid frequency measurement value Fgrid_ref with its previous value or a predetermined fixed value (such as 50 Hz), and replacing the phase synchronization signal Ncyc_ref_Sync with its previous value or a predetermined fixed value (such as 0). The inter-grid phase difference signal ϕglobal is optional, and thus set to a predetermined fixed value (such as 0) to synchronize θref adj. In the cell grid, all the DGRs 40 can thus operate independently in synchronization even during a main grid outage. When the main grid is restored, the GPS time synchronization operation is resumed. Once the grids are synchronized, the synchronization checking circuit breaker can be closed to transition to the grid interconnection operation. Alternatively, the cell grid independent operation can be simply continued.

To prevent the cell grid from continuing independent operation without the synchronization checking circuit breaker (21) being opened despite the outage of the main grid (15), the grid interconnection controller (MGC 30) has grid interconnection protective functions including islanding detection. When active islanding is detected, the output of the reactive power of each cooperative autonomous distributed device (DGR 40) can be adjusted to trigger the protective function and open the synchronization checking circuit breaker (21). The MGC 30 also has the FRT function to maintain the synchronization checking circuit breaker (21) closed during an instantaneous main grid outage.

### [(A) Cell Grid Black Start Operation]

When the main grid experiences an outage during grid interconnection, there is a rated delay of 3 to 5 cycles, or 0.06 to 0.1 sec or so, from the detection of the main grid outage to the switching of the synchronization checking circuit breaker 21 from closed to open using a high-voltage vacuum circuit breaker (VCB), for example. When the main grid experiences an outage during grid interconnection, the cell grid system voltage can also drop with the main grid voltage, possibly to 0 V. Returning to the independent operation from such a state is referred to as a black start.

For such a case, it may be determined in advance to maintain the main grid frequency measurement value f 41 at its previous value or replace the main grid frequency measurement value f 41 with a rated value, and maintain the phase synchronization signal Ncyc_ref_Sync 45 at its previous value or replace the phase synchronization signal Ncyc_ref_Sync 45 with a predetermined fixed value. When the voltage becomes zero, this enables the cell grid to be disconnected from the main grid with all the DGRs 40 maintaining synchronization inside, make a black start, and then transition to independent operation. This is because all the DGRs 40 have the GPS time t′ 42 (FIG. 3A), i.e., tref 92 (FIG. 3D) and perform calculations with reference thereto.

### [(A) Time Synchronization Error]

If the main grid and the cell grid are disconnected and the main grid frequency f 31 and the phase synchronization signal Ncyc_ref_Sync remain unchanged, θref (=2π·Ncyc_ref) thus obtained by each DGR 40 is synchronous with θref of the main grid within voltage errors of 1% (equivalent to within time errors of 5 μsec). With this level of errors, the main grid and the cell grid can be said to be synchronous, and the synchronization checking circuit breaker 21 can be turned on to connect the grids without passing an abnormal current between the grids.

### [(A) Effect of Transmission Delay Time]

If the frequency or phase of the main grid changes with the main grid and the cell grid disconnected, the change is transmitted to the DGRs 40 with time delays such as a transmission delay time from the MGC 30 to the DGRs 40 and calculation times in the MGC 30 and the DGRs 40. The cell grid thus becomes temporarily out of synchronization with the main grid. If the synchronization checking circuit breaker 21 attempts to turn on to connect the two grids in such a state, the synchronization checking function can take effect to prevent the circuit breaker from turning on. However, after a lapse of the transmission delay time, the voltage phase of the cell grid is synchronized with that of the main grid and the circuit breaker turns on. This transmission delay time is about the same as the delay in the network communication, and typically within 0.1 to 1 sec or so depending on the communication environment.

### [(A) Inertia and Synchronizing Force]

With the main grid and the cell grid connected, the frequencies f and the rotational phase angle signals θref of the two grids have common values because of the physical connection of the two grids. Now, when a change occurs in the frequency or the rotational phase angle of the main grid, the MGC 30 is unable to transmit the change to the respective DGRs 40 for the duration of the transmission delay time. The frequencies and rotational phase angles of the respective DGRs 40 thus follow with a delay as much as this delay time. It therefore appears to the main grid that the respective DGRs 40 and the cell grid behave as if they have high inertia as a whole. Moreover, since the respective DGRs 40 and the cell grid start to follow the main grid after this delay time, it appears that the DGRs 40 and the cell grid have strong synchronizing force.

The limiters 60 in the controllers of the DGRs 40 limit the transmitted frequency fluctuations of the main grid as well. If the limitation width is narrow, the frequency fluctuations of the main grid are harder to follow, and the DGRs 40 and the cell grid behave as if the inertia has increased. If the limitation width is wide, the frequency fluctuations are easier to follow, and the DGRs 40 and the cell grid behave as if the inertia has decreased. The same applies when there is more than one cell grid. In isolated power systems such as those on remote islands, where the cell grid is small in scale but accounts for more than half of the total demand, the limitation width for the rate of change of frequency can be narrowed to make the cell grid robust against frequency fluctuations, so that the cell grid shifts gradually to behave like a main grid. In other words, the cell grid is a power system having controllable inertia.

Next, between the two synchronization techniques for synchronizing the frequencies and phases of all the DGRs 40 within the cell grid, “(B) voltage-based synchronization technique” will be described.

### [Basic Description of (B) Voltage-Based Synchronization Technique]

Voltage-based synchronization techniques are standard techniques for interconnected micro-grids. This method has been widely implemented, tested, and deployed worldwide. When a cell grid is in connection with the main grid, fluctuations in the cell grid are absorbed by the main grid and do not cause any adverse effect. By contrast, when a group of inverters operates independently from the main grid and controls the independent operation of the cell grid, the frequency is difficult to maintain. Moreover, the cell grid is unable to make a simultaneous black start. Techniques for solving such issues will now be described.

Initially, the voltage-based synchronization control method has the following advantages.
Use the voltage of the distribution lines in the cell grid as the synchronization signal:
   Additional special equipment such as GPS signals and receivers are not needed;
   The synchronization signal, voltage, is extremely robust; and
   The operation can be continued unless the power lines fail or are damaged.
The voltage synchronization signal automatically adjusts the following issues:
   Voltage variations and phase shifts of the transformers; and
   Voltage drops and phase shifts due to circuit impedance.
The DGRs 40 can be connected to and disconnected from the cell grid without any special configuration.
The DGRs 40 flexibly accommodate manual or automatic changes made to the circuit configuration of the cell grid.

There are disadvantages as follows.
Unable to synchronize during cell grid independent operation where the cell grid is disconnected from the main grid:
   Too large fluctuations under typical frequency droop control; and
   The synchronization signal from the MGC 30 proposed here is needed.
Unable to make a black start during a cell grid outage:
   GPS time-based synchronization signals are needed.

The reason why synchronization is unable to be achieved during the cell grid independent operation where the cell grid is disconnected from the main grid will now be described. When the cell grid is operating independently, the total output of all the DGRs 40 and the total demand within the cell grid need to match each other. As shown in FIG. 2F, the actual current Idgr corresponding to the actual demand therefore flows with a discrepancy from the target Idgr*. As a result, the actual cell grid voltage Vgrid exhibits a phase difference of Δδ from the target Vgrid*. If Δδ is 0, the frequency and phase are stable. Once the balance between the total output and the total demand is disturbed and Δδ has a positive or negative value, the absolute value of Δδ will continue to increase.

For example, if the real power output of the DGR 40 exceeds the real power of the actual load, the actual voltage Vgrid advances relative to the target voltage Vgrid* in phase, and Δδ always has a positive value. Since the PLL moves the target voltage Vgrid* to match the actual voltage Vgrid, the phase of θref increases through positive feedback. As a result, the PLL frequency increases continuously.

On the other hand, if the real power output of the DGR 40 is lower than the real power of the actual load, the actual voltage Vgrid lags behind the target voltage Vgrid* in phase and Δδ always has a negative value. The PLL constantly reduces the phase of θref through a positive feedback loop. As a result, the PLL frequency decreases continuously. In either case, the phase difference between the PLL and the mini-grid does not stabilize, nor does the frequency.

As described above, the voltage-based synchronization is unusable for the cell grid in the independent operation state independent of the grid. This is ascribable to the absence of a robust power source that absorbs and provides differences in the actual reactive power between the DGR 40 and the load. Conversely, with a robust power source, the actual voltage Vgrid is stable and the cell grid will not fall into a positive feedback loop even if the target voltage Vgrid* is controlled to approach the actual voltage Vgrid.

[(B) Introduction of Inter-Grid Phase Difference Signal ϕglobal]

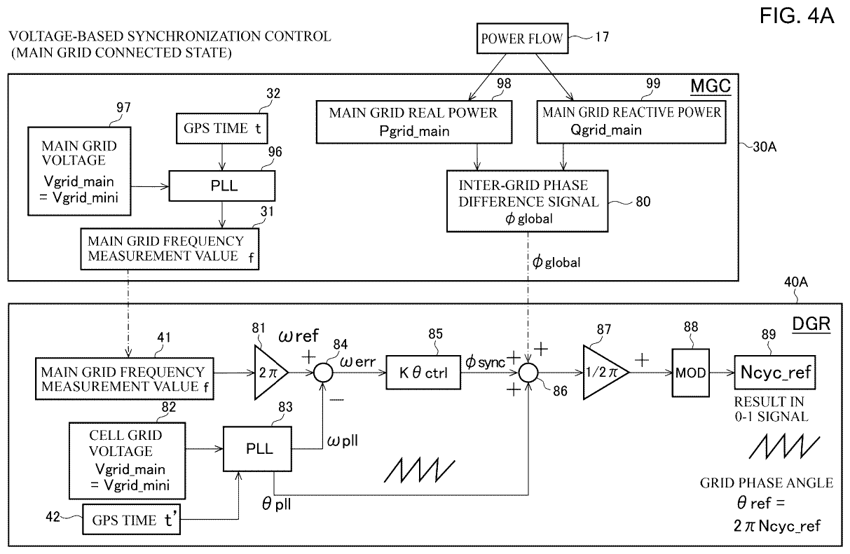

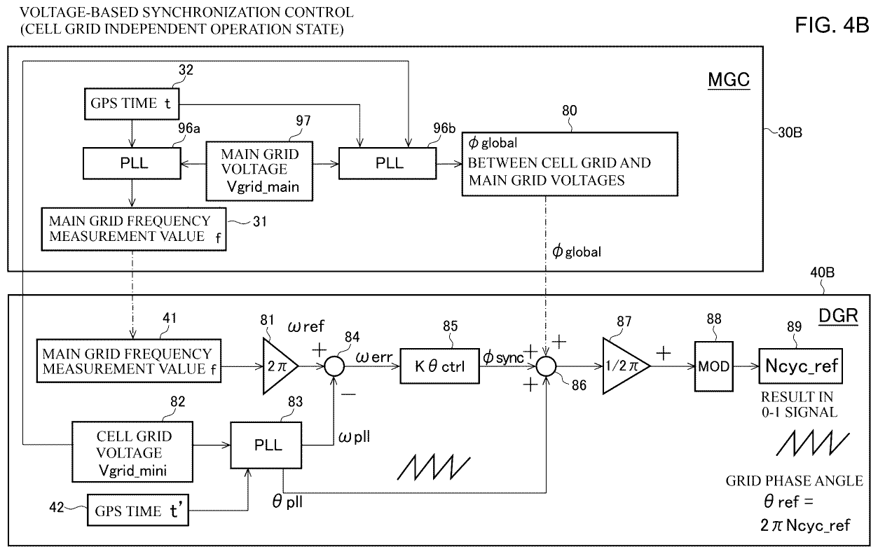

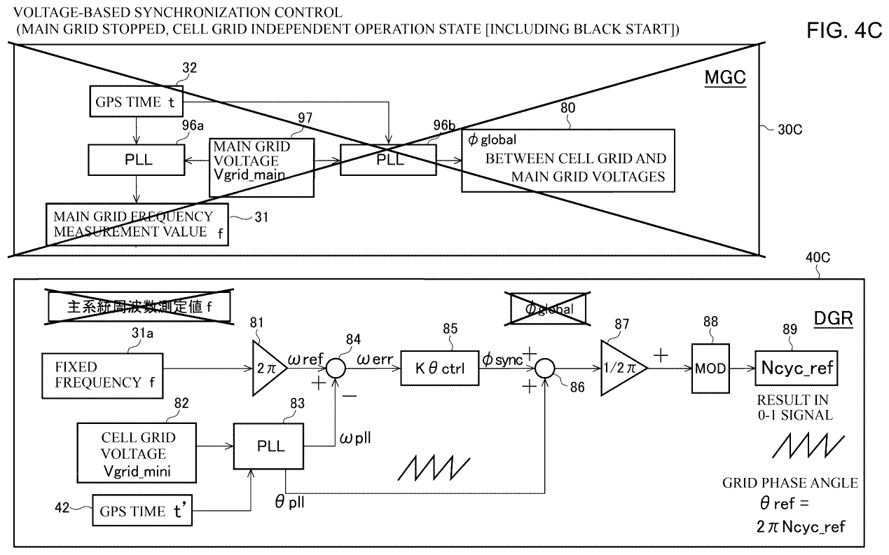

The following technique has been devised to prevent the cell grid in the independent operation state independent of the main grid from falling into such a positive feedback loop. In other words, a method for stabilizing the frequency and phase of the cell grid by transmitting the main grid frequency signal f and the inter-grid phase difference signal ϕglobal to all the DGRs 40 via the MGC 30 will be proposed. For the phase angle signal θref, as shown in FIG. 4B, ϕsync is initially generated by feedback control Kθctrl 85 for reducing an error between a reference angular frequency ωref and a mini-grid angular frequency ωgrid. An adder 86 adds a phase angle signal θpll obtained by the PLL of each DGR 40 thereto to generate a local grid phase angle signal Ncyc_ref 89. Note that with this control alone, the voltage phase of the cell grid causes a positive feedback as described above and will not stabilize.

For such a reason, as shown in FIG. 4B, the adder 86 further adds ϕglobal 80. ϕglobal is the signal indicating the phase difference between the main grid and the cell grid. While the main grid and the cell grid are disconnected, ϕglobal changes as the phase of the cell grid deviates from that of the main grid. The addition of ϕglobal can prevent the phase-widening positive feedback loop and suppress instability of the phase and, by extension, frequency of the cell grid. In such a manner, the frequency of the cell grid is stabilized without direct connection to the main grid but by using only the information. All the DGRs 40 within the cell grid are thereby synchronized and the frequency can be stabilized even during the independent operation without connection to the main grid. Since the two grids are synchronous, the synchronization checking circuit breaker can be turned on to connect the two grids at any time.

That ϕglobal is effective even with the main grid and the cell grid connected will be described with reference to FIG. 4A. Since real power flows as the phase difference between the two grids widens, ϕglobal measures power flow 17 flowing between the two grids and compares the power flow 17 with the target real power and reactive power to generate a needed phase difference signal ϕglobal, and transmits the phase difference signal ϕglobal to all the DGRs 40. The outputs of all the DGRs 40 can thereby be increased or decreased to control the power flow between the two grids to match the target value.

When the main grid is in an outage state and the cell grid is operating independently, the reference voltage phase based on the internal clock is generated instead of the voltage phase of the main grid, and the phase difference signal with the cell grid voltage phase is transmitted to all the DGRs 40 as ϕglobal via the MGC 30. The frequency and phase of the cell grid can thereby be synchronized.

Next, the reason why the standard time signal is needed in making a black start when the MGC 30 is stopped and the cell grid is experiencing an outage will be described. As described above, with the main grid and the cell grid connected, the voltage phase of the main grid serves as the reference. With the main grid and the cell grid disconnected, voltage phase information about the main grid can be obtained via the MGC 30. Even during a main grid outage, the phase derived from the internal clock of the MGC 30 can be transmitted to all the DGRs 40 as a common reference via the MGC 30.

However, in a state where the MGC 30 is stopped and disconnected from the main grid, there is no common voltage phase information across all the DGRs 40. Similarly, in a state where the cell grid is stopped, there is no common voltage phase information across all the DGRs 40. In such a case, a common synchronization signal needs to be supplied to all the DGRs 40 by using other means. If the DGRs 40 acquire standard time information, a synchronous voltage phase can be generated in all the DGRs 40 by correcting the internal clocks based on the standard time information.

A method for stabilizing the frequency and phase of the cell grid using the standard time information in such a manner in making a black start after a cell grid outage or when the cell grid is operating independently with the MGC 30 stopped will be proposed.

### [(B) Detailed Description of Voltage-Based Synchronization Technique]

Voltage-based synchronization control methods will be described with reference to FIGS. 4A, 4B, and 4C. FIG. 4A is a control block diagram of the main grid connected state with voltage synchronization according to Embodiment 1 of the present invention. FIG. 4B is a control block diagram of a cell grid system independent state (synchronous control) with voltage synchronization according to Embodiment 1 of the present invention. FIG. 4C is a control block diagram of a cell grid system independent state (during a main grid outage) with voltage synchronization according to Embodiment 1 of the present invention. The block diagrams and the control methods in the respective states will now be described.

### [(B) Synchronization Technique When Main Grid Is Connected]

In the voltage-based synchronization technique, when the cell grid is in connection with the main grid, a difference between the signal based on the frequency of the main grid and the signal based on the frequency detected by the PLL of each DGR 40 is controlled to decrease, and the phase angle signal is also detected and taken into account. The target voltage Vgrid* and the actual voltage Vgrid thus become substantially the same. FIG. 2E shows such a state, which is the same as during GPS time synchronization.

[(B) Description with Reference to Block Diagram When Main Grid Is Connected]

A block diagram where Ncyc_ref 89 is calculated by a cooperative autonomous distributed device (DGR) 40A in a state where the cell grid system is in connection with the main grid will be described with reference to FIG. 4A. FIG. 4A is a block diagram of voltage-based synchronization control according to Embodiment 1 of the present invention, and serves as a control diagram in the grid interconnected state. A grid interconnection controller (MGC) 30A and the cooperative autonomous distributed device (DGR) 40A are included. In the grid interconnection controller (MGC) 30A, an inter-grid phase difference signal ϕglobal calculation unit 80 generates the inter-grid phase angle ϕglobal from the main grid real power Pgrid_main and the main grid reactive power Qgrid_main measured by a grid real power Pgrid_main measurement unit 98 and a main grid reactive power Qgrid_main measurement unit 99, with the power flow between the main grid 15 and the cell grid system 28 taken into consideration.

The main grid frequency measurement device 31 will initially be described. A main grid voltage acquisition unit 97 acquires the main grid voltage Vgrid_main. In the main grid connected state, the main grid voltage and the cell grid voltage are the same, i.e., Vgrid_main=Vgrid_mini.

A PLL 96 calculates the main grid frequency measurement value f 31 from the main grid voltage Vgrid_main, and transmits the signal to the DGRs 40 via the MGC 30. The inter-grid phase difference signal ϕglobal 80 calculation unit calculates the inter-grid phase difference signal ϕglobal based on differences between the measurements of the main grid real power Pgrid_main and the main grid reactive power Qgrid_main flowing between the main grid and the cell grid and not-shown respective target values, and transmits the signal to the DGRs 40 via the MGC 30. Assume that the direction in which power flow flows toward the cell grid is positive. As the inter-grid phase difference signal ϕglobal increases, the phase angle of the cell grid system lags behind that of the main grid and the power flow from the main grid to the cell grid system increases. As the inter-grid phase difference signal ϕglobal decreases, the phase angle of the cell grid system advances and the reverse power flow from the cell grid system to the main grid increases. In such a manner, the outputs of the DGRs 40 are changed to match the power flow flowing between the two grids with the target value. As for the reactive power, a voltage correction signal is transmitted to the DGRs 40 via the MGC 30 instead of ϕglobal 80. Since the technique is similar, a detailed description thereof will be omitted.

A PLL 83 of the cooperative autonomous distributed device (DGR) 40A generates the cell grid system phase angle signal θpll and a cell grid system angular velocity signal ωpll from the cell grid voltage Vgrid_mini. The main grid frequency measurement value acquisition unit 41 receives the main grid frequency measurement value f measured by the main grid frequency measurement device 31, and calculates a main grid angular velocity signal ωref=2π·f. The PLL 83 calculates the cell grid system angular velocity signal ωpll from the cell grid voltage Vgrid_mini. Next, a comparator calculates an inter-grid angular velocity error signal ωerr=ωref−ωpll. Next, a controller kθ_ctrl 85 performs PI calculation with ωerr as its input, thereby calculating a control phase signal ϕsync. kθ_ctrl has a proportional gain and an integral gain. The gains are adjusted to be constant for low-frequency components and smaller for high-frequency components so that kθ_ctrl is less susceptible to abrupt changes in frequency.

The adder 86 adds the cell grid system phase angle signal θpll and the inter-grid phase angle ϕglobal to the control phase signal sync. A divider divides the resulting signal by 2π. Furthermore, the residue of division using the MOD function is calculated to extract only the fractional part, whereby the sawtooth-shaped output Ncyc_ref 89 is obtained. Ncyc_ref is further multiplied by 2π to obtain a cell grid system rotational phase angle signal (hereinafter, may be referred to as “cell grid system phase angle signal”) θref=2π·Ncyc_ref. While the present embodiment uses the MOD function, the MOD function may be replaced with the foregoing functions for extracting the fractional part.

The cell grid system phase angle signal θref=2π·Ncyc_ref thus obtained by each cooperative autonomous distributed device (DGR) 40A is synchronous with the main grid voltage (=cell grid voltage). In the case of a system that is in a steady state and stable, the PLL frequency is constant. Thus, ωref=ωpll, ωerr=0, and ϕsync=0. As a result, θpll generated by the PLL of each DGR 40 becomes dominant. Combined with the inter-grid phase angle ϕglobal, this enables control of the power flow and reverse power flow between the cell grid system and the main grid.

In the event of an abrupt change in grid frequency or phase, ωref becomes not equal to ωpll but with a transmission time delay. The PLL 83 monitors the cell grid voltage (=main grid voltage) and generates θpll, and thus follows the abrupt change immediately (within one cycle or so). While the power flow between the main grid and the cell grid changes abruptly, ϕglobal is transmitted with a time delay. The rises and falls of ϕglobal are restricted to not change abruptly. The synchronizing force and the inertia of the cell grid are thus maintained by the power flow connecting the two grids and the PLLS.

### [(B) When Cell Grid Is Independent]

A block diagram where a cooperative autonomous distributed device (DGR) 40B in a cell grid independent state calculates Ncyc_ref will be described with reference to FIG. 4B. FIG. 4B is a block diagram of voltage-based synchronization control according to Embodiment 1 of the present invention, and serves as a control diagram in a cell grid independent operation state separated from the grid. A grid interconnection controller (MGC) 30B and the cooperative autonomous distributed device (DGR) 40B are included. Components similar to those of FIGS. 1 to 4A are denoted by the same reference numerals. Descriptions thereof will be omitted. The inter-grid phase difference signal ϕglobal calculation unit 80 processes the measured main grid voltage Vgrid_main and cell grid voltage Vgrid_mini using a PLL 96b and calculates a phase angle difference therebetween as the inter-grid phase difference signal ϕglobal.

ϕglobal in FIG. 4B differs from ϕglobal in FIG. 4A in terms of input. In the case of FIG. 4B, the two grids are disconnected, and the purpose is to adjust the voltage phase of the DGR 40B to that of the main grid so that the synchronization checking circuit breaker 21 can be closed at any time. In FIG. 4B, the difference between the voltage phases of the two grids is therefore calculated as ϕglobal. When the main grid and the cell grid system are in a steady state and stable during the independent operation, a signal indicating ϕglobal=0 is transmitted. The two grids thus have the same voltage phases, and can be connected at any time. In the event of an abrupt change in grid frequency or phase, ωref becomes not equal to ωpll. Since the two grids are disconnected, the phase angle difference between the main grid and the cell grid temporarily widens. However, the voltage phases become the same again and the two grids return to the state of being connectable at any time after a lapse of time as much as the transmission time delay.

### [(B) Use of Standard Time Signal]

As has been described above, the standard time signal is not needed in the configurations of FIGS. 4A and 4B. However, as will be described in detail below, voltage-based synchronization techniques are unusable while an MGC 30C is stopped or upon a black start as shown in FIG. 4C. The reason is that while the target frequency can be switched to a fixed value, the phase-related common index ϕglobal is lost. On such occasions, a target voltage signal Vgrid* having a phase common for all DGRs 40C is needed. The standard time signal can be used for that purpose. The voltage phase common for all the DGRs 40C can be provided based on the standard time. This aspect is characterized in that even with voltage-based synchronization control, Vgrid* is synchronized between all the DGRs 40 through internal clock correction using the standard time signal.

### [(B) During Main Grid Outage, Cell Grid Independent State]

FIG. 4C shows a method where all the DGRs 40C continue synchronous operation to achieve a cell grid independent operation in a state where the main grid is stopped. With the main grid stopped, the synchronization checking circuit breaker turns off and the information from the MGC 30C is lost. In such a case, the independent operation of the cell grid can be continued with all the DGRs 40C synchronized, by maintaining the main grid frequency measurement value f 41 at its previous value or replacing the main grid frequency measurement value f 41 with a rated value, and maintaining the inter-grid phase difference signal ϕglobal at its previous value or replacing the inter-grid phase difference signal ϕglobal with a fixed value (including zero) prepared in advance.

### [(B) When MGC 30C Is Stopped]

The MGC 30C may stop without the main grid voltage being lost. In such a case, the operation of the DGRs 40C can be continued by storing a GPS time-based voltage vector and rated frequency information in each DGR 40C as described above, and operating the DGRs 40C at the rated frequency with the voltage vector as Vgrid* in FIG. 2E.

Suppose that the MGC 30C is running and some (less than 20% in capacity) of the DGRs 40C become unable to receive the information from the MGC 30C. Even in such a case, the remaining DGRs 40C maintain the entire cell grid robust, and the DGRs 40 unable to receive the information from the MGC 30C can continue synchronous operation by switching to the ordinary voltage-based synchronization method.

### [(B) Implementation of Black Start]

When the main grid voltage is lost, the voltage within the cell grid can become zero despite the disconnection of the synchronization checking circuit breaker. The restoration of the cell grid from the zero voltage corresponds to what is called a black start. In the present invention, as described above, the GPS time-based reference voltage vector is stored in each DGR 40C. A black start can be made by operating the DGRs 40C using the reference voltage vector as Vgrid* in FIG. 2E upon the black start.

### Embodiment 2

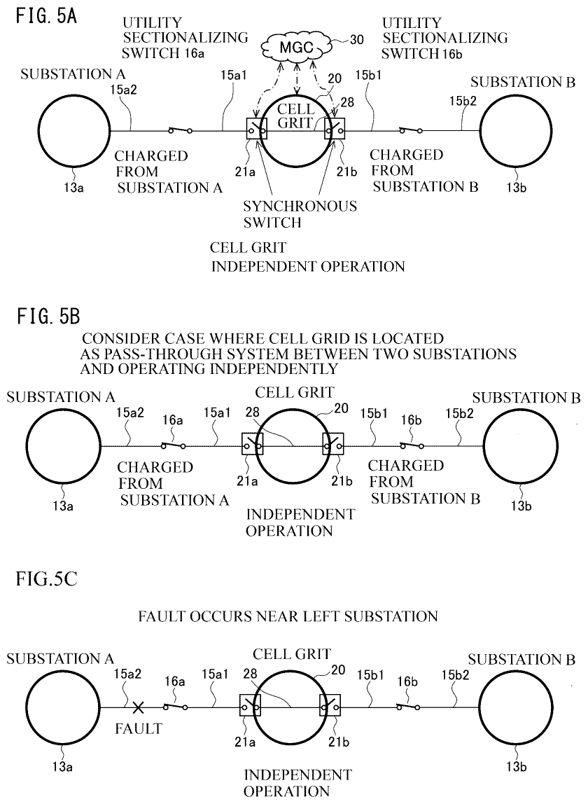

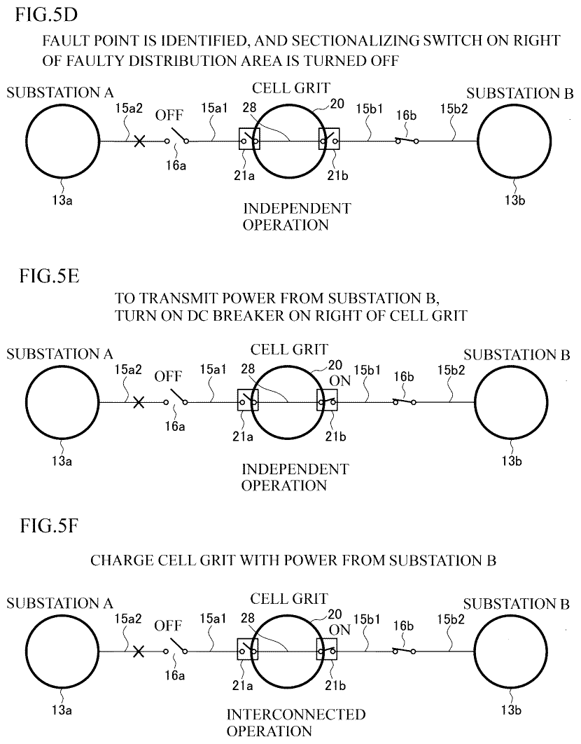

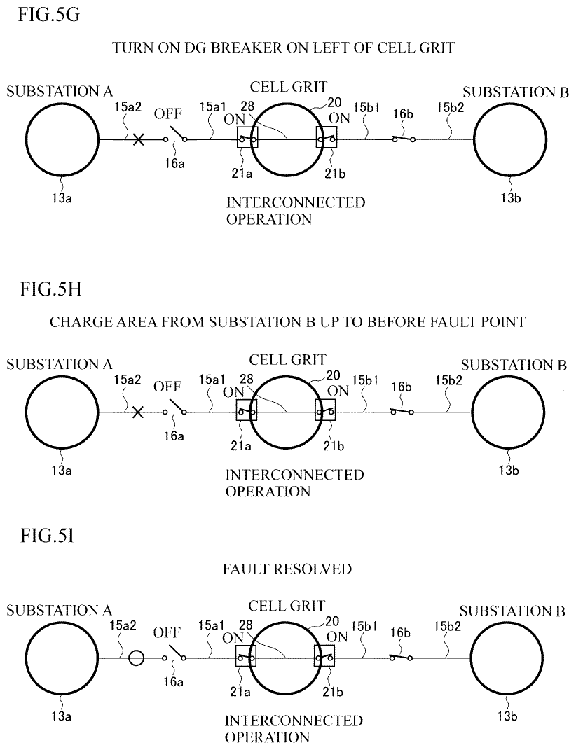

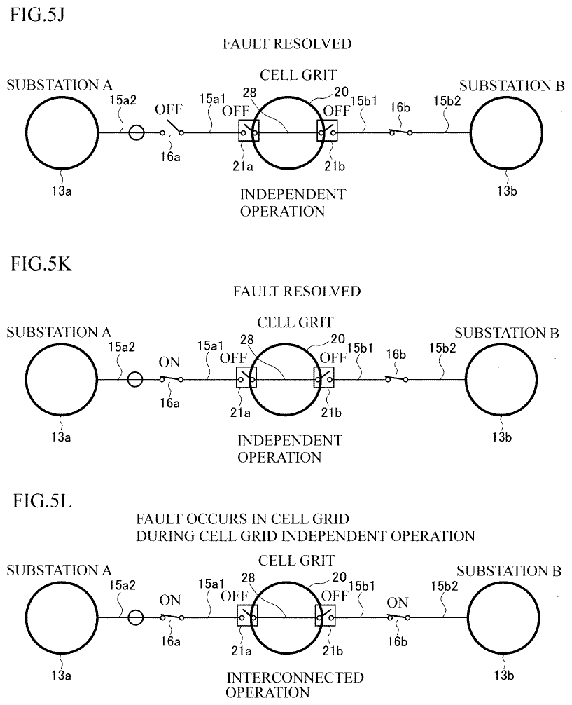

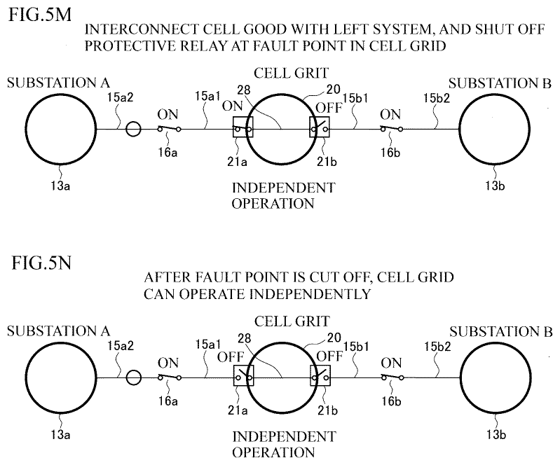

A cooperative autonomous distributed grid interconnection system according to Embodiment 2 of the present invention will be described with reference to FIGS. 5A to 5N. FIGS. 5A to 5N are explanatory diagrams of first to fourteenth states of cell grid connection according to Embodiment 2 of the present invention. Components similar to those of FIGS. 1 to 4C are denoted by the same reference numerals. Descriptions thereof will be omitted. The configuration of the cell grid 20 is the same as that in Embodiment 1. Embodiment 2 deals with an example where the cell grid system 28 is connected to a plurality of main grids 15.

In FIGS. 5A to 5N, the cell grid 20 is connected to both a main grid 15a, which includes a main system 15a1 and a main system 15a2 connected to a substation A, and a main grid 15b, which includes a main system 15b1 and a main system 15b2 connected to a substation B, via synchronization checking circuit breakers 21a and 21b, respectively. Such connection of the cell grid 20 connected to two main grids 15a and 15b may be referred to as a “pass-through system”.

Like Embodiment 1, the cell grid 20 includes a plurality of cooperative autonomous distributed devices (DGRs) 40. Each DGR 40 is controlled by control signals from a grid interconnection controller (MGC) 30 and can be interconnected with the main grid 15a or 15b. The synchronization checking circuit breakers 21a and 21b are also controlled by control signals from the MGC 30. The connection and disconnection of the cell grid system 28 and the main grids 15a and 15b are controlled by the control signals from the MGC 30. Part of the MGC 30 is physically integrated with the synchronization checking circuit breakers. The cell grid 20 includes the two synchronization checking circuit breakers 21a and 21b. One of the synchronization checking circuit breakers, 21a, is connected to the main grid 15a that is the grid of a substation A 13a. The other synchronization checking circuit breaker 21b is connected to the main grid 15b that is the grid of a substation B 13b.

In the main grid 15a, a utility sectionalizing switch 16a is disposed between the synchronization checking circuit breaker 21a and the substation A 13a. The main system 15a1 is disposed between the synchronization checking circuit breaker 21a and the sectionalizing switch 16a, and the main system 15a2 is disposed between the sectionalizing switch 16a and the substation A 13a.

In the main grid 15b, a utility sectionalizing switch 16b is disposed between the synchronization checking circuit breaker 21b and the substation B 13b. The main system 15b1 is disposed between the synchronization checking circuit breaker 21b and the sectionalizing switch 16b, and the main system 15b2 is disposed between the sectionalizing switch 16b and the substation B 13b.

[Restoration Control After Fault in Main Grid 15a]

Referring to FIGS. 5A to 5K, the states from when a fault occurs in the system 15a2 to when the fault is resolved and electricity is supplied as before will be described. Even when the fault occurs in the system 15a2, the cell grid system 28 continues constant power supply using the power generation facilities 23 within the cell grid 20.

In the state of FIG. 5A, both the synchronization checking circuit breakers 21a and 21b are open, and the cell grid 20 is operating independently.

In the state of FIG. 5B, both the synchronization checking circuit breakers 21a and 21b are open, and the cell grid 20 is operating independently. The sectionalizing switch 16a is closed, and the power from the substation A 13a is supplied to the system 15al via the system 15a2. The systems 15a1 and 15a2 are both charged with the power from the substation A 13a. Similarly, the sectionalizing switch 16b is closed, and the power from the substation B 13b is supplied to the system 15b1 via the system 15b2. The systems 15b1 and 15b2 are both charged with the power from the substation B 13b.

In the state of FIG. 5C, the system 15a2 is experiencing a fault such as a short-circuit fault. Once the occurrence of the fault in the system 15a2 is identified, the sectionalizing switch 16a is immediately opened as in the state of FIG. 5D.

In the state of FIG. 5D, the sectionalizing switch 16a is open, and the system 15al is not supplied with any power. Even in such a case, the synchronization checking circuit breakers 21a and 21b are open, and the cell grid 20 is operating independently. The cell grid system 28 thus continues supplying power using the power generation facilities within the cell grid 20.

In the state of FIG. 5D, there is no abnormality in the system 15al, and the MGC 30 plans to control the power supply from the substation B 13b to the system 15a1 in cooperation with the utility company's power supply department. Initially, frequency and phase synchronization control is performed so that the cell grid system 28 can be synchronously interconnected with the system 15b1.

In the state of FIG. 5E, after the cell grid system 28 is synchronized with the system 15b1, the synchronization checking circuit breaker 21b is closed to interconnect with the system 15b1.

In the state of FIG. 5F, the interconnected operation of the cell grid system 28 with the system 15b1 can supply the power from the substation B 13b to the cell grid system 28 via the system 15b2, the system 15b1, and the synchronization checking circuit breaker 21b. The cell grid system 28 can thereby be charged with the power from the substation B 13b.

In the state of FIG. 5G, the synchronization checking circuit breaker 21a is closed to connect the cell grid system 28 to the system 15a1, which is a normal system experiencing an outage.

In the state of FIG. 5H, with the synchronization checking circuit breaker 21a closed, the power from the substation B 13b is supplied to the system 15al via the cell grid system 28. The system 15b2, the system 15b1, the cell grid system 28, and the system 15al are thus charged with the power from the substation B 13b.

In the state of FIG. 5I, the faulty system 15a2 is restored, and the power from the substation A 13a is supplied to the system 15a2. Here, the MGC 30 plans to control the power supply from the substation A 13a to the system 15a1, which has been powered by the substation B 13b via the cell grid system 28, as before in cooperation with the utility company's power supply department.

In the state of FIG. 5J, the synchronization checking circuit breakers 21a and 21b are opened. With the synchronization checking circuit breakers 21a and 21b open, the cell grid 20 operates independently. Here, the system 15a1 is not powered from either substation 13a or 13b.

In the state of FIG. 5K, the sectionalizing switch 16a is closed to supply the power from the substation A 13a to the system 15al via the system 15a2. The outage due to the occurrence of the fault in the system 15a2 is thereby restored.

### [Restoration Control in Event of Fault in Cell Grid During Independent Operation]

Referring to FIGS. 5L to 5N, restoration control in the event of a fault in the cell grid 20 during the independent operation of the cell grid 20 will be described.

In the state of FIG. 5L, the cell grid is in an independent operation state. Each DGR 40 in the cell grid 20 is performing synchronization control to synchronize with the system 15a1. Suppose that a fault occurs in the cell grid 20 here. When a fault such as a short-circuit fault occurs in the cell grid during the independent operation of the cell grid, there can be cases where a shot-circuit current large enough to shut off the protective relay at the fault point fails to be supplied to the fault point from the power generation facilities within the cell grid. Examples of situations where the protective relay can fail to be triggered to cut off the fault point include where the protection level of the protective relay is set based on the main grid. When the fault continues for a certain time and the voltage is not restored, the state transitions to that of FIG. 5M.

In the state of FIG. 5M, the cell grid system 28 and the system 15a1 are synchronous, and the synchronization checking circuit breaker 21a can thus be immediately closed. With the synchronization checking circuit breaker 21a closed, a short-circuit current is supplied from the main grid to the fault point in the cell grid. When a short-circuit current reaching or exceeding the shut-off level is supplied to the fault point, the protective relay at the fault point is triggered to cut off the fault point.

In the state of FIG. 5N, the voltage is restored since the fault point in the cell grid 20 is cut off. The interconnected operation can be simply continued, or the synchronization checking circuit breaker 21a can be opened again so that the cell grid 20 operates independently.

Here, the cell grid system 28 and the system 15a1 are described to be interconnected to supply the short-circuit current to the fault point in the cell grid 20 and shut off the protective relay at the fault point. However, the present embodiment is not limited thereto. For example, instead of the system 15a1, the cell grid system 28 and the system 15b1 may be interconnected to supply the short-circuit current to the fault point in the cell grid 20 and shut off the protective relay at the fault point.

### Embodiment 3

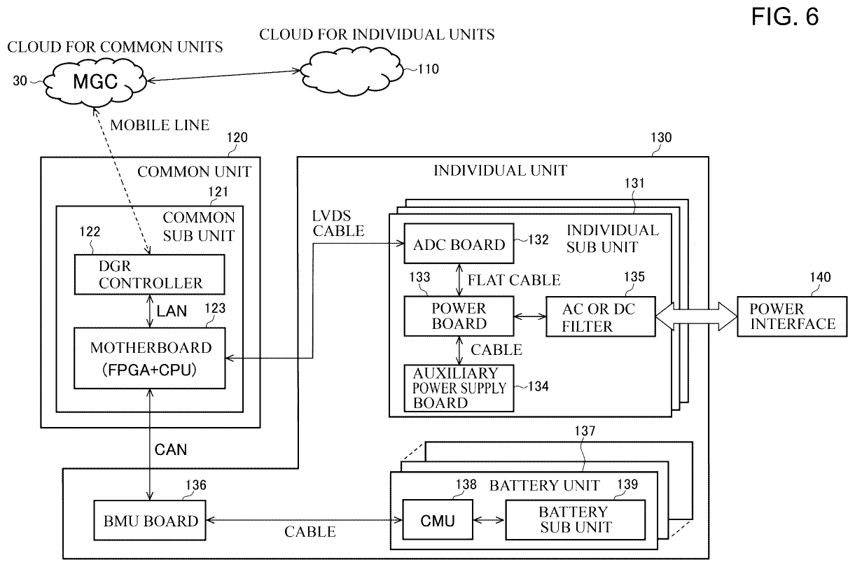

A cooperative autonomous distributed grid interconnection system according to Embodiment 3 of the present invention will be described with reference to FIG. 6. Components similar to those of FIGS. 1 to 5N are denoted by the same reference numerals, and descriptions thereof will be omitted. FIG. 6 is a block diagram of the cooperative autonomous distributed grid interconnection system according to Embodiment 3 of the present invention.

A cooperative autonomous distributed device (DGR) 40 includes a common unit 120 and an individual unit 130, and communicates with a grid interconnection controller (MGC) 30 via a mobile circuit. The MGC 30 is implemented in the cloud as a cloud for common units. Part of the MGC 30 is built in a synchronization checking circuit breaker 21. The MGC 30 can obtain various types of information about the individual unit 130 by communicating with a cloud for individual units 110.

The common unit 120 has the same configuration across all DGRs 40. A common sub unit 121 included in the common unit 120 includes a DGR controller 122 and a motherboard 123. The DGR controller 122 and the motherboard 123 communicate with each other via a LAN. The motherboard 123 includes a CPU and an FPGA (Field Programmable Gate Array). The FPGA is an LSI that can be programmed by the MGC 30. Since the FPGA is rewritable, the common unit 120 can be used for all sorts of DGRs 40 in common.

The individual unit 130 includes individual sub units 131, a BMU (Battery Management Unit) board 136, and battery units 137. The individual unit 130 includes a plurality of individual sub units 131, e.g., three individual sub units 131. Each of the individual sub units 131 is connected to the motherboard 123 by an LVDS (Low Voltage Differential Signaling) cable.

The individual sub unit 131 includes an ADC (Analog-to-Digital Converter) board 132, a power board 133, an auxiliary power supply board 134, and an AC or DC filter 135. The ADC board 132 outputs a switching pulse signal transmitted through the LVDS cable to the power board 133. The power board 133 is connected to the ADC board 132 by a FLAT cable. The power board 133 outputs switching pulses based on the switching pulse signal from the ADC board 132, using power from the auxiliary power supply board 134 as control power supply, and supplies the switching pulses to a power interface 140 via the AC or DC filter 135.

A voltage value and a current value detected by the power interface 140 are input to the ADC board 132 via the AC or DC filter 135 and the power board 133. The ADC board 132 inputs the detected voltage value and current value to the motherboard 123 as digital signals via the LVDS cable.

The BMU board 136 communicates with the motherboard 123 using a CAN (Controller Area Network). The individual unit 130 includes a plurality of battery units 137, e.g., 11 battery units 137. The BMU board 136 and each battery unit 137 are connected by a cable.

The battery unit 137 includes a CMU (Cell Management Unit) 138 and a battery sub unit 139. The BMU board 136 monitors and controls the state of each battery unit 137 based on command signals from the motherboard 123. The CMU 138 communicates with the BMU board 136, and controls and protects the battery sub unit 139. The BMU board 136 controls the entire battery units and monitors abnormalities based on information about the respective CMUs 138. For example, fire accidents of lithium-ion batteries and the like can thereby be prevented. The BMU board 136 and the battery units 137 may be disposed integrally with or separate from the DGR 40.

In the DGR 40, the motherboard 123 of the common unit 120 performs all control calculations in a centralized manner. The individual unit 130 drives hardware based on control signals output by the control calculations of the motherboard 123.

The motherboard 123 outputs switching pulses to the ADC board 132 via the LVDS cable. The ADC board 132 supplies control signals including the switching pulses from the LVDS cable to the power board 133 via the FLAT cable. The power board 133 supplies the switching pulses to the power interface 140 via the AC or DC filter 135 based on the switching pulses and the like calculated by the motherboard 123, using the auxiliary power supply board 134 as the control power supply. Information such as the voltage value and current value detected by the power interface 140 is transmitted to the ADC board 132 via the AC or DC filter 135 and the power board 133, converted into digital signals by the ADC board 132, and collected by the motherboard 123 through communication via the LVDS cable and used for control calculations.

The motherboard 123 also performs control calculations of the battery units 137 in a centralized manner. More specifically, the BMU board 136 controls, protects, and monitors all the battery sub units 139 via the CMU 138 based on control signals calculated by the motherboard 123.

The FPGA and CPU on the motherboard 123 can be freely reprogrammed by the MGC 30. The DGR 40 can thus be freely reconfigured via the cloud. This enables various settings, such as three-phase settings, single-phase settings, 380-V voltage settings, 200-V voltage settings, direct-current settings for solar power, direct-current settings for storage batteries, and direct-current settings for fuel cells. Various units can thereby be implemented with the same hardware by modifying the software vie the cloud. DGRs 40 can therefore be used not only throughout Japan but also worldwide.

The individual unit 130 does not include any main control unit such as a microcomputer. All the control calculations are performed by the motherboard 123, and the individual unit 130 is driven by the control signals from the motherboard 123. For example, switching pulse signals calculated by the motherboard 123 are supplied to three half-bridges in each of three individual sub units 131, i.e., a total of nine half-bridges. The number of units and the number of half-bridges can be increased or decreased. The motherboard 123 obtains the detection signals of the voltage values, current values, and the like from power interfaces 140 at various locations through LDVS cables as digital data, and performs all the control calculations of the DGR 40.

With the common unit 120 commonized and the board-to-board interfaces standardized, the individual unit 130 can be provided as various application products. All the system operations can be implemented in the cloud by the MGC 30. Moreover, the latest software can always be used by the MGC 30 updating the software of the motherboard 123 via the cloud.

The DGR controller 122 can extract information about solar light, generators, and the like connected to the half-bridges, and battery information, and transmit the information to the cloud for comprehensive use in addition to the information about the power, voltage, and the like from the motherboard 123. Information about geographically distributed DGRs 40 can also be used as weather information and the like. Necessary information may be encrypted and transmitted to blockchain ledgers to create infrastructure for local currencies and the like.

To calculate the switching pulses, the motherboard 123 desirably uses hysteresis control. The hysteresis control will now be described with reference to FIGS. 2B and 2C. The hysteresis control is a current control using a hysteresis current control method, which differs from the prevalent PWM control. In the PWM control, when a short-circuit fault occurs during cell grid standalone operation, an overcurrent flows instantaneously and the inverter is shut down for overcurrent protection. In contrast, the hysteresis control can suppress current even in the event of a short-circuit fault, since it controls the current.

A target current Iref to achieve a target voltage Vref is calculated by the following Eq. (2):

$${i}_{ref} = {i}_{dgr} + \frac{{v}_{ref} - {v}_{dgr}}{{T}_{sw}} \cdot {C}_{filter} \qquad ( 2 )$$

Here, Tsw=1/fsw is a switching period. Idgr is a current flowing through the load of the cell grid. The target current Iref changes with the load current Idgr. The second term on the right-hand side represents a correction current to achieve the target voltage Vref, which corresponds to ΔI=C·dV/dt.

The hysteresis control can directly control the current and make Vdgr follow the target voltage Vref. In other words, the DGR 40 can obtain target power by making IL follow the target current Iref through the hysteresis control and further controlling Vdgr to match the target voltage Vref.

In the hysteresis control, an upper band Δib and a lower band −Δib are set above and below the target current Iref. Operations are repeated to, when IL exceeds the upper band Δib, turn off the switch on the upper arm and turn on the switch on the lower arm, and when IL falls below the lower band −Δib, turn off the switch on the lower arm and turn on the switch on the upper arm.

In FIG. 2C, at time to, IL falls below the lower band −Δib. The switch on the lower arm is thus turned off and the switch on the upper arm is turned on, whereby +Vdc is applied to Lfiler. Next, at time t1, IL exceeds the upper band Δib. The switch on the upper arm is turned off and the switch on the lower arm is turned on, whereby −Vdc is applied to Lfiler. Next, at time t2, IL falls below the lower band −Δib. The switch on the lower arm is turned off and the switch on the upper arm is turned on, whereby +Vdc is applied to Lfiler. The duration from time to t0 time t2 is the switching period Tsw.

Here, the switching frequency varies as the gradient of IL changes with the voltage difference across Lfilter. To suppress variations in the switching frequency, the band widths of the upper band Δib and the lower band −Δib are changed according to the following Eq. (3):

$$Δ {i}_{b} = \frac{{V}_{dc}^{2} - {v}_{dgr}^{2}}{{V}_{dc}} \cdot \frac{{T}_{sw}}{4 {L}_{filter}} \qquad ( 3 )$$

If the switching frequency varies constantly with a wide bandwidth, EMC filters are difficult to design. The variable band width control can converge the switching frequency to fsw, which makes EMC filter design easier.

The foregoing embodiments are not intended to limit the present invention thereto, and equally applicable to other embodiments within the scope of the patent claims. Furthermore, the respective embodiments can be modified as appropriate and/or combined as appropriate.

1. A cooperative distributed grid interconnection system comprising:
a synchronization checking circuit breaker that is capable of connecting or disconnecting a main grid and a cell grid system;
a grid interconnection controller that detects power information about the main grid and power information about the cell grid system; and
one or more cooperative autonomous distributed devices that are connected within the cell grid system and perform power conversion to synchronously interconnect with each other, wherein:
the grid interconnection controller and each of the cooperative autonomous distributed devices include a standard time signal acquisition device that acquires a standard time signal;
each of the cooperative autonomous distributed devices receives frequency information and phase information transmitted from the grid interconnection controller based on the standard time signal, or a combined signal of the frequency information and the phase information;
when the synchronization checking circuit breaker is open, each of the cooperative autonomous distributed devices controls a voltage phase of the cell grid system so that the voltage phase of the cell grid system is synchronized with that of the main grid; and
when the synchronization checking circuit breaker is closed, each of the cooperative autonomous distributed devices controls a power flow between the main grid and the cell grid system.

2. The cooperative distributed grid interconnection system according to claim 1, wherein:
the grid interconnection controller generates an inter-grid phase difference signal and transmits the inter-grid phase difference signal to each of the cooperative autonomous distributed devices;
when the synchronization checking circuit breaker is closed, each of the cooperative autonomous distributed devices controls the power flow and a reverse power flow using the inter-grid phase difference signal; and
even if the synchronization checking circuit breaker is open and information from the grid interconnection controller is unable to be received, each of the cooperative autonomous distributed devices can perform synchronization control on the cell grid system based on the standard time signal.

3. The cooperative distributed grid interconnection system according to claim 1, wherein:
the standard time signal acquisition device includes a first standard time acquisition unit that acquires a first standard time signal, and a second standard time acquisition unit that acquires a second standard time signal;
the grid interconnection controller includes the first standard time acquisition unit, generates a phase synchronization signal as the combined signal of the frequency information and the phase information by applying the first standard time signal to a main grid frequency and a main grid rotational phase angle, and outputs the phase synchronization signal to the cooperative autonomous distributed device; and
the cooperative autonomous distributed device includes the second standard time acquisition unit, and demodulates a cell grid system rotational phase angle signal synchronous with the main grid rotational phase angle by applying the second standard time signal to the phase synchronization signal output from the grid interconnection controller and the main grid frequency.

4. The cooperative autonomous distributed grid interconnection system according to claim 1, wherein:
the grid interconnection controller measures a main grid frequency measurement value with the power information about the main grid and/or the power information about the cell grid system as an input, generates an inter-grid phase difference signal, and outputs the inter-grid phase difference signal to the cooperative autonomous distributed device; and
the cooperative autonomous distributed device generates a cell grid system phase angle signal and a cell grid system angular velocity signal from the cell grid system voltage, and calculates a cell grid system rotational phase angle signal from the cell grid system phase angle signal, the cell grid system angular velocity signal, the main grid frequency measurement value, and the inter-grid phase difference signal.

5. The cooperative autonomous distributed grid interconnection system according to claim 4, wherein:
the grid interconnection controller measures the main grid frequency measurement value using a first phase synchronization circuit;
the cooperative autonomous distributed device generates the cell grid system phase angle signal and the cell grid system angular velocity signal using a second phase synchronization circuit; and
the standard time signal acquisition device includes a first standard time acquisition unit that inputs a first standard time to the first phase synchronization circuit, and a second standard time acquisition unit that inputs a second standard time to the second phase synchronization circuit.

6. The cooperative autonomous distributed grid interconnection system according to claim 1, wherein if the cell grid system is capable of connecting to a plurality of main grids via the synchronization checking circuit breakers and an abnormality occurs in a first main grid among the main grids, the cell grid system can interconnect with a second main grid other than the first main grid and transmit power to an area where the abnormality is not occurring in the first main grid.

7. The cooperative distributed grid interconnection system according to claim 1, wherein:
if the synchronization checking circuit breaker is closed and the main grid experiences an outage, the synchronization checking circuit breaker is switched from closed to open, and each of the cooperative autonomous distributed devices independently operates the cell grid system; and
if the synchronization checking circuit breaker is open and a fault occurs in the cell grid system, the synchronization checking circuit breaker is closed and the power flow is controlled to supply a fault current to a fault point, so that a protective relay at the fault point is triggered to cut off the fault point.

8. The cooperative distributed grid interconnection system according to claim 1, wherein the cooperative autonomous distributed device includes a common unit including a motherboard, and one or more individual units, and the motherboard performs control calculation including pulse wave generation.

9. The cooperative distributed grid interconnection system according to claim 8, wherein calculation for the pulse wave generation by the motherboard uses hysteresis control.

10. A grid interconnection method of a cooperative distributed grid interconnection system including:
a synchronization checking circuit breaker that is capable of connecting or disconnecting a main grid and a cell grid system;
a grid interconnection controller that detects power information about the main grid and power information about the cell grid system; and
one or more cooperative autonomous distributed devices that are connected within the cell grid system and perform power conversion to synchronously interconnect with each other, the grid interconnection method comprising:
a step in which the grid interconnection controller and each of the cooperative autonomous distributed devices acquire a standard time signal;
a step in which each of the cooperative autonomous distributed devices receives frequency information and phase information transmitted from the grid interconnection controller based on the standard time signal, or a combined signal of the frequency information and the phase information;
a step in which, when the synchronization checking circuit breaker is open, each of the cooperative autonomous distributed devices controls a voltage phase of the cell grid system so that the voltage phase of the cell grid system is synchronized with that of the main grid; and
a step in which, when the synchronization checking circuit breaker is closed, each of the cooperative autonomous distributed devices controls a power flow between the main grid and the cell grid system.

11. A program that causes a computer to perform the steps of the grid interconnection method of the cooperative autonomous distributed grid interconnection system according to claim 10.
